(19) United States
(12) Patent Application Publication
(10) Pub. No.: US 2018/0050513 A1
(43) Pub. Date: Feb. 22, 2018

(54) Anti-Fogging and Anti-Fouling Laminate and Method for Producing Same, Article and Method for Producing Same, and Anti-Fouling Method

(71) Applicant: Dexerials Corporation, Tokyo (JP)

(72) Inventors: Mikihisa Mizuno, Tokyo (JP); Shinobu Hara, Tokyo (JP); Shogo Sakamoto, Tokyo (JP); Ryosuke Endo, Tokyo (JP); Takashi Iwamura, Tokyo (JP)

(21) Appl. No.: 15/555,767

(22) PCT Filed: Feb. 24, 2016
(86) PCT No.: PCT/JP2016/055469

§ 371 Date: Sep. 5, 2017

(30) Foreign Application Priority Data
Mar. 9, 2015 (JP) 2015-045847

(51) Int. Cl. B32B 3/30; B32B 27/08; B32B 37/15; B32B 27/36; B29C 59/02; B29C 45/16

(52) U.S. Cl. CPC B32B 3/30; B32B 27/08; B32B 37/15; B29K 2669/00; B29C 59/026; B29C 45/16; B32B 2307/728; B32B 27/365

(57) ABSTRACT

An anti-fogging and anti-fouling laminate, including a substrate made of a resin; and an anti-fogging and anti-fouling layer on the substrate made of a resin, wherein the anti-fogging and anti-fouling layer comprises micro convex portions or micro concave portions in a surface thereof wherein the anti-fogging and anti-fouling layer comprises a hydrophilic molecular structure, and wherein a pure water contact angle of the surface of the anti-fogging and anti-fouling layer is 90° or more.

### TECHNICAL FIELD

The present invention relates to an anti-fogging and anti-fouling laminate, which has anti-fogging and anti-fouling properties, can be used in a wide variety of fields including building use, industrial use, automobile use, optical use and solar battery panels, and can be manufactured in a simple molding process and a method for manufacturing the anti-fogging and anti-fouling laminate, a product using the anti-fogging and anti-fouling laminate and a method for manufacturing the product, and an anti-fouling method using the anti-fogging and anti-fouling laminate.

### BACKGROUND ART

To decorate and protect the surfaces of products, resin films and glass and the like are attached to the surfaces.

However, the resin films and glass decorating and protecting the surfaces of products sometimes get cloudy and dirty to reduce visibility and good appearance of the products.

To prevent reduction of visibility and good appearance of products, a hydrophobization treatment is applied to the resin films and glass.

As a technique of the hydrophobization treatment, for example, a water-retaining sheet is proposed including a micro protrusion structure provided with a group of micro protrusions, where a compound containing one or more kinds of atoms selected from a fluorine atom and a silicon atom is deposited on the surface of the micro protrusion structure by a chemical vapor treatment, and a static pure water contact angle on the surface on the micro protrusion structure side is 90° to 160° by the θ/2 method (see, for example, PTL 1).

However, this proposed technique has a problem with low manufacture efficiency because a micro protrusion structure is formed and a compound containing one or more kinds of atoms selected from a fluorine atom and a silicon atom is further deposited thereon.

### CITATION LIST

### Patent Literature

PTL 1 Japanese Patent (JP-B) No. 5626395

### SUMMARY OF INVENTION

### Technical Problem

An object of the present invention is to solve the aforementioned problems in the art and attain the following object. More specifically, an object of the present invention is to provide an anti-fogging and anti-fouling laminate, which is excellent in anti-fogging and anti-fouling properties and is also in manufacture efficiency, and a method for manufacturing the anti-fogging and anti-fouling laminate, a product using the anti-fogging and anti-fouling laminate and a method for manufacturing the product, and an anti-fouling method using the anti-fogging and anti-fouling laminate.

### Solution to Problem

Means for solving the aforementioned problems are as follows.

<1> An anti-fogging and anti-fouling laminate, including:

a substrate made of a resin, and

an anti-fogging and anti-fouling layer on the substrate made of a resin,

wherein the anti-fogging and anti-fouling layer includes micro convex portions or micro concave portions in a surface thereof,

wherein the anti-fogging and anti-fouling layer includes a hydrophilic molecular structure, and

wherein a pure water contact angle of the surface of the anti-fogging and anti-fouling layer is 90° or more.

<2> The anti-fogging and anti-fouling laminate according to <1>, wherein an elongation percentage of the anti-fogging and anti-fouling laminate is 10% or more.

<3> The anti-fogging and anti-fouling laminate according to <1> or <2>, wherein a Martens hardness of the anti-fogging and anti-fouling layer is 20 N/mm² to 300 N/mm².

<4> The anti-fogging and anti-fouling laminate according to any one of <1> to <3>, wherein an average surface area ratio of the anti-fogging and anti-fouling layer is 1.1 or more.

<5> The anti-fogging and anti-fouling laminate according to any one of <1> to <4>, wherein the anti-fogging and anti-fouling layer includes a cured product of an active energy ray curable resin composition, and the active energy ray curable resin composition includes an organic compound including at least one of fluorine and silicon.

<6> The anti-fogging and anti-fouling laminate according to <5>, wherein the active energy ray curable resin composition includes a compound including at least one of a polyoxyalkyl group and a polyoxyalkylene group.

<7> A method for manufacturing the anti-fogging and anti-fouling laminate according to any one of <1> to <6>, the method including:

forming an uncured resin layer by applying an active energy ray curable resin composition to a substrate made of a resin; and

forming an anti-fogging and anti-fouling layer by bringing a transfer matrix comprising micro convex portions or micro concave portions into contact with the uncured resin layer, irradiating the uncured resin layer in contact with the transfer matrix with an active energy ray to cure the uncured resin layer, thereby transferring the micro convex portions or the micro concave portions.

<8> The method for manufacturing an anti-fogging and anti-fouling laminate according to <7>, wherein a surface of the transfer matrix to be brought into contact with the uncured resin layer is treated with a compound including at least one of fluorine and silicon.

<9> The method for manufacturing an anti-fogging and anti-fouling laminate according to <7> or <8>, wherein the micro convex portions or the micro concave portions of the transfer matrix are formed by etching a surface of the transfer matrix with a photoresist having a predetermined pattern shape used as a protective film.

<10> The method for manufacturing an anti-fogging and anti-fouling laminate according to <7> or <8>, wherein the micro convex portions or the micro concave portions of the transfer matrix are formed by laser processing of a surface of the transfer matrix by irradiating the surface of the transfer matrix with a laser beam.

<11> A product, including:

an anti-fogging and anti-fouling laminate on a surface thereof the anti-fogging and anti-fouling laminate being the anti-fogging and anti-fouling laminate according to any one of <1> to <6>.

<12> A method for manufacturing the product according to <11>, the method including:

heating the anti-fogging and anti-fouling laminate;

molding the anti-fogging and anti-fouling laminate heated into a desired shape; and

injecting a molding material to the anti-fogging and anti-fouling laminate molded in the desired shape at a side of a substrate made of a resin and molding the molding material.

<13> The method for manufacturing the product according to <12>, wherein the heating is performed by infrared heating.

<14> An anti-fouling method for protecting a product from getting dirty, the method including:

laminating an anti-fogging and anti-fouling laminate on a surface of the product, the anti-fogging and anti-fouling laminate being the anti-fogging and anti-fouling laminate according to any one of <1> to <6>.

### Advantageous Effects of the Invention

According to the present invention, the problems in the art are overcome and the objects of the present invention can be attained, and it is possible to provide an anti-fogging and anti-fouling laminate, which is excellent in anti-fogging and anti-fouling properties and is also in manufacture efficiency, and a method for manufacturing the anti-fogging and anti-fouling laminate, a product using the anti-fogging and anti-fouling laminate and a method for manufacturing the product, and an anti-fouling method using the anti-fogging and anti-fouling laminate.

### BRIEF DESCRIPTION OF DRAWINGS

FIG. 1A is an atomic force microscope (AFM) image showing an example of a surface of an anti-fogging and anti-fouling layer having convex portions;

FIG. 1B is a cross sectional view along the a-a line in FIG. 1A;

FIG. 2A is an AFM image showing an example of a surface of an anti-fogging and anti-fouling layer having concave portions;

FIG. 2B is a cross sectional view along the a-a line in FIG. 2A;

FIG. 3A is a perspective view showing an example of the constitution of a roll matrix that is a transfer matrix;

FIG. 3B is a plane view represented by enlarging a part of the roll matrix shown in FIG. 3A;

FIG. 3C is a cross sectional view along the track T in FIG. 3B;

FIG. 4 is a schematic diagram showing an example of the constitution of an exposure apparatus for a roll matrix for preparing a roll matrix;

FIG. 5A is a process drawing for describing an example of a process for preparing a roll matrix;

FIG. 5B is a process drawing for describing an example of a process for preparing a roll matrix;

FIG. 50C is a process drawing for describing an example of a process for preparing a roll matrix;

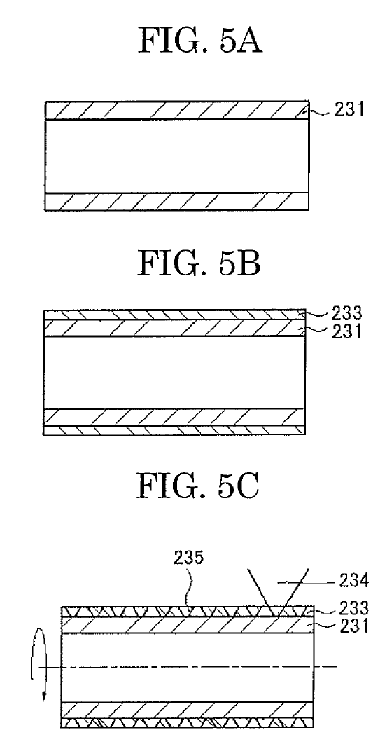

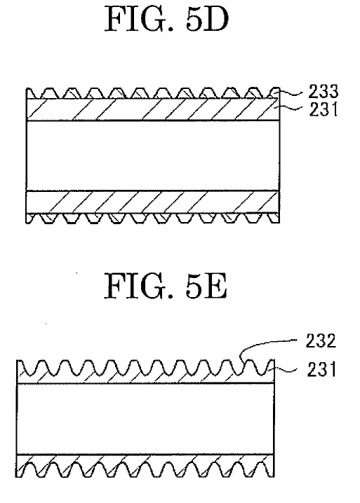

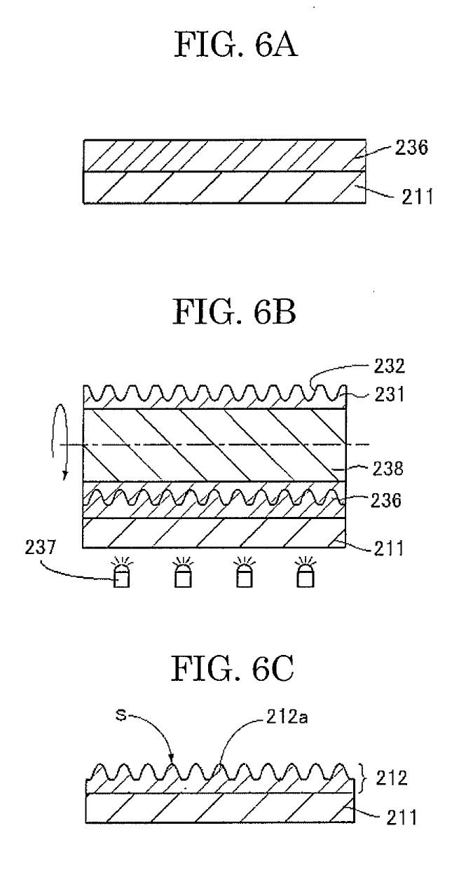

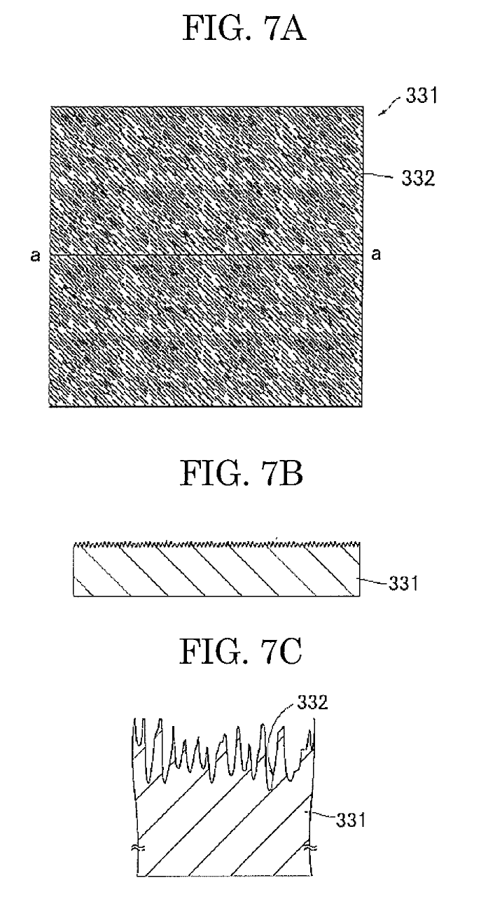

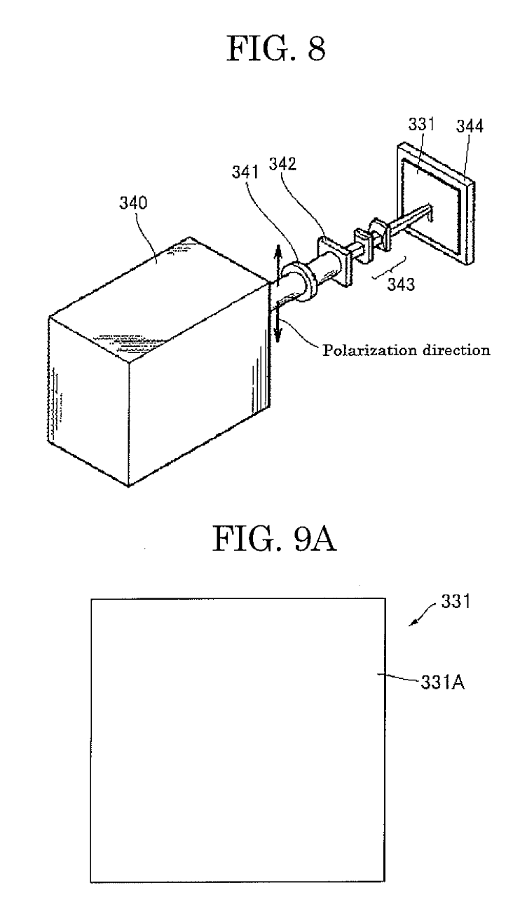

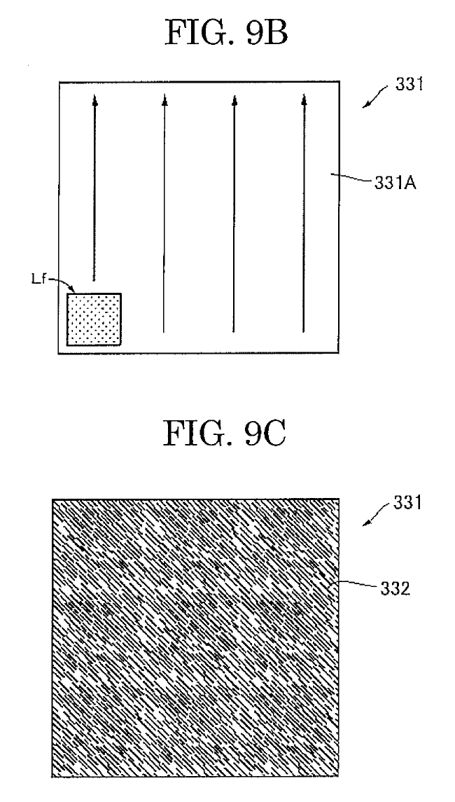

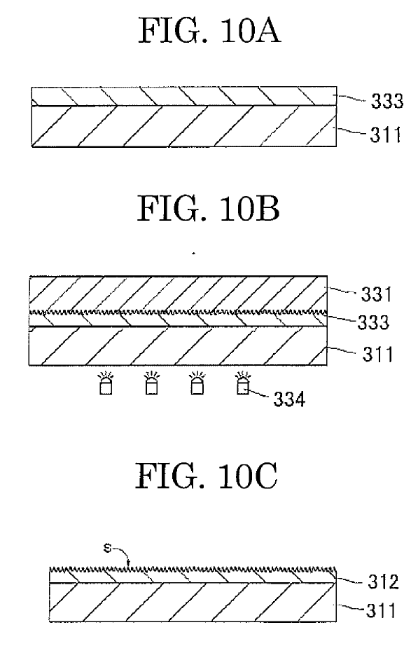

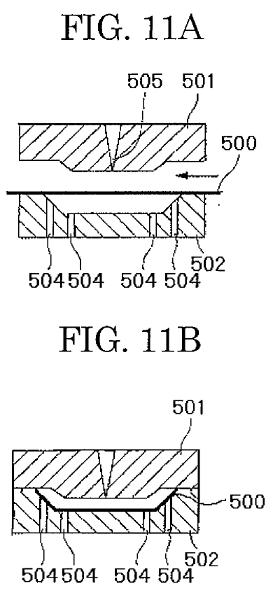

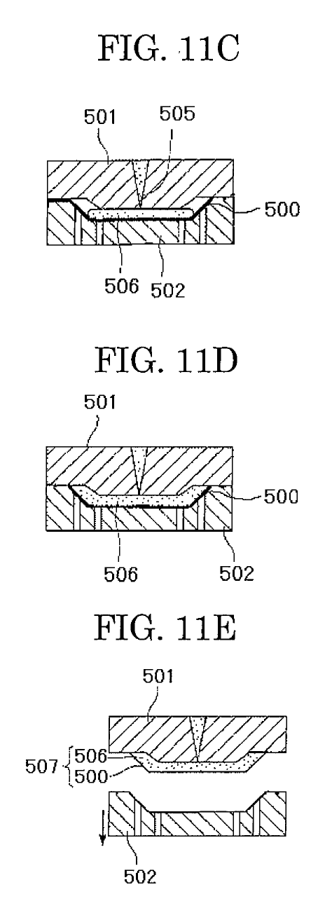

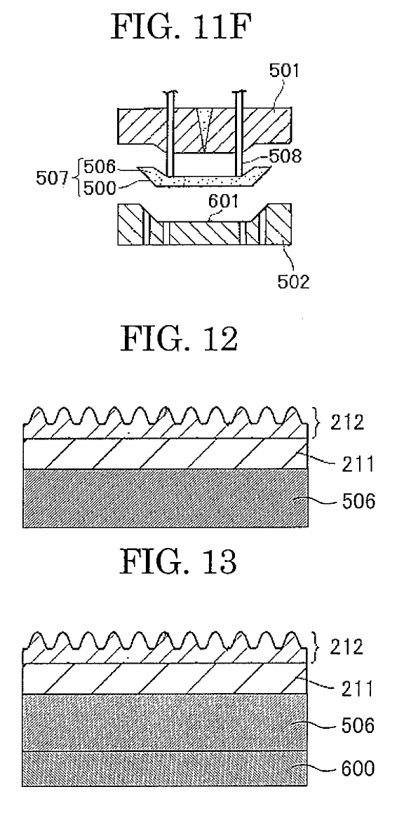

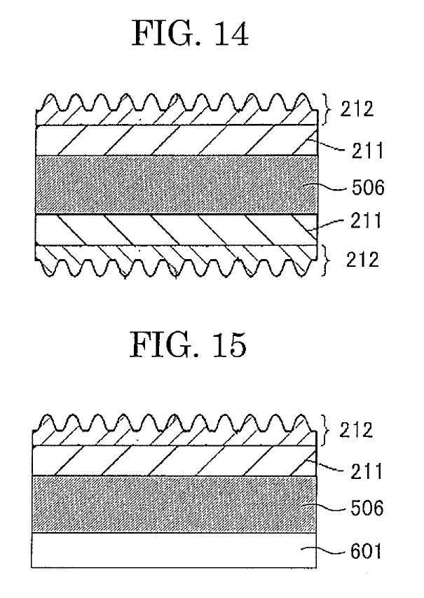

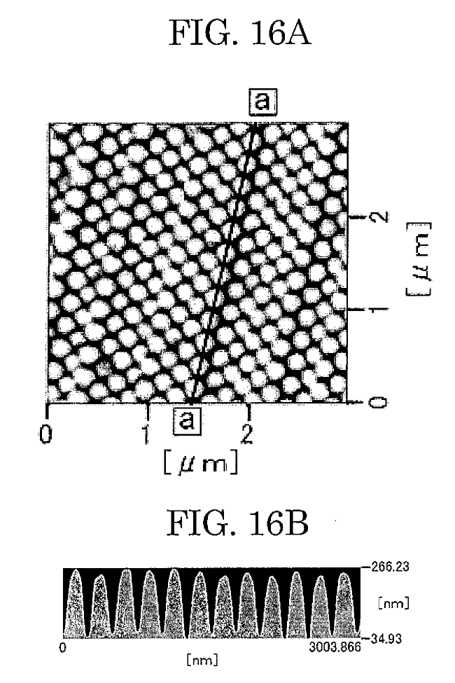

FIG. 5D is a process drawing for describing an example of a process for preparing a roll matrix;

FIG. 5E is a process drawing for describing an example of a process for preparing a roll matrix;

FIG. 6A is a process drawing for describing an example of a process for transferring micro convex portions or concave portions by a roll matrix;

FIG. 6B is a process drawing for describing an example of a process for transferring micro convex portions or concave portions by a roll matrix;

FIG. 6C is a process drawing for describing an example of a process for transferring micro convex portions or concave portions by a roll matrix;

FIG. 7A is a plane view showing an example of the constitution of a sheet-like matrix that is a transfer matrix;

FIG. 7B is a cross sectional view along the a-a line shown in FIG. 7A;

FIG. 7C is a cross sectional view represented by enlarging a part of FIG. 7B;

FIG. 8 is a schematic diagram for showing an example of the constitution of a laser processing apparatus for preparing a sheet-like matrix;

FIG. 9A is a process drawing for describing an example of a process for preparing a sheet-like matrix;

FIG. 9B is a process drawing for describing an example of a process for preparing a sheet-like matrix;

FIG. 9C is a process drawing for describing an example of a process for preparing a sheet-like matrix;

FIG. 10A is a process drawing for describing an example of a process for transferring micro convex portions or concave portions by a sheet-like matrix;

FIG. 10B is a process drawing for describing an example of a process for transferring micro convex portions or concave portions by a sheet-like matrix;

FIG. 10C is a process drawing for describing an example of a process for transferring micro convex portions or concave portions by a sheet-like matrix;

FIG. 11A is a process drawing for describing an example of manufacturing a product of the present invention by in-mold molding;

FIG. 11B is a process drawing for describing an example of manufacturing a product of the present invention by in-mold molding;

FIG. 11C is a process drawing for describing an example of manufacturing a product of the present invention by in-mold molding;

FIG. 11D is a process drawing for describing an example of manufacturing a product of the present invention by in-mold molding;

FIG. 11E is a process drawing for describing an example of manufacturing a product of the present invention by in-mold molding;

FIG. 11F is a process drawing for describing an example of manufacturing a product of the present invention by in-mold molding;

FIG. 12 is a schematic cross sectional view of an example of a product of the present invention (part 1);

FIG. 13 is a schematic cross sectional view of an example of a product of the present invention (part 2);

FIG. 14 is a schematic cross sectional view of an example of a product of the present invention (part 3);

FIG. 15 is a schematic cross sectional view of an example of a product of the present invention (part 4);

FIG. 16A is an AFM image showing a surface of an anti-fogging and anti-fouling layer of an anti-fogging and anti-fouling laminate of Example 1; and

FIG. 16B is a cross sectional view along the a-a line in FIG. 16A.

### DESCRIPTION OF EMBODIMENTS

### (Anti-Fogging and Anti-Fouling Laminate)

The anti-fogging and anti-fouling laminate of the present invention includes at least: a substrate made of a resin, and an anti-fogging and anti-fouling layer; and further contains other members as necessary.

### <Substrate Made of a Resin>

The material for the substrate made of a resin is not particularly limited and can be appropriately selected depending upon the purpose. Examples of the material include triacetylcellulose (TAC), polyester (TPEE), polyethylene terephthalate (PET), polyethylenenaphthalate (PEN), polyimide (PI), polyamide (PA), aramid, polyethylene (PE), polyacrylate, polyethersulfone, polysulfone, polypropylene (PP), polystyrene, diacetylcellulose, poly(vinyl chloride), an acrylic resin (PMMA), polycarbonate (PC), an epoxy resin, a urea resin, a urethane resin, a melamine resin, a phenolic resin, an acrylonitrile-butadiene-styrene copolymer, a cycloolefin polymer (COP), a cycloolefin copolymer (COC), a PC/PMMA laminate, and a rubber-added PMMA.

The substrate made of a resin preferably has transparency.

The form of the substrate made of a resin, which is not particularly limited and can be appropriately selected depending upon the purpose, is preferably a film form.

If the substrate made of a resin is a film, the average thickness of the substrate made of a resin, which is not particularly limited and can be appropriately selected depending upon the purpose, is preferably 5 μm to 1,000 μm and more preferably 50 μm to 500 μm.

On the surface of the substrate made of a resin, letters, patterns and images, etc. may be printed.

On the surface of the substrate made of a resin, a binder layer may be provided in order to increase adhesion between the substrate made of a resin and a molding material in forming the anti-fogging and anti-fouling laminate in a molding process or in order to protect the letters, patterns and images from flow resistive pressure of the molding material during a molding process. As the material for the binder layer, binders made of acryl, urethane, polyester, polyamide, ethylenebutyl alcohol and an ethylene-vinyl acetate copolymer; and adhesives can be used. Note that the binder layer may be formed of two layers or more. As the binder to be used, a binder having heat-sensitivity and pressure-sensitivity suitable for a molding material can be selected.

### <Anti-Fogging and Anti-Fouling Layer>

The anti-fogging and anti-fouling layer has micro convex portions or micro concave portions in the surface.

The pure water contact angle of the surface of the anti-fogging and anti-fouling layer is 90° or more.

The anti-fogging and anti-fouling layer contains a hydrophilic molecular structure.

The anti-fogging and anti-fouling layer is formed on the substrate made of a resin.

Since the surface of the anti-fogging and anti-fouling layer itself has hydrophobic property, the anti-fogging and anti-fouling laminate is obtained which is more excellent in abrasion resistance than when a compound containing one or more kinds of atoms selected from a fluorine atom and a silicon atom is deposited on the micro protrusion structure as in the technique described in JP-B No. 5626395.

The anti-fogging and anti-fouling layer is preferably an anti-fogging and anti-fouling layer made of a resin because of easiness in manufacture.

The anti-fogging and anti-fouling layer, which is not particularly limited and can be appropriately selected depending upon the purpose, preferably contains a cured product of an active energy ray curable resin composition.

The hydrophilic molecular structure is not particularly limited and can be appropriately selected depending upon the purpose so long as it is a molecular structure that is hydrophilic. Examples thereof include organic molecular structures that are hydrophilic, and specific examples thereof include a polyoxyalkyl group and a polyoxyalkylene group. The hydrophilic molecular structure can be introduced into the anti-fogging and anti-fouling layer by, for example, using the below-described hydrophilic monomer when producing the anti-fogging and anti-fouling layer.

### —Micro Convex Portion and Micro Concave Portion—

The anti-fogging and anti-fouling layer contains micro convex portions or micro concave portions in a surface thereof.

The micro convex portions or micro concave portions are formed in the surface of the anti-fogging and anti-fouling layer, which is an opposite surface to the surface facing the substrate made of a resin.

The micro convex portions herein refer to those formed on the surface of the anti-fogging and anti-fouling layer and arranged at an average interval (distance) of 1,000 nm or less.

The micro concave portions herein refer to those formed in the surface of the anti-fogging and anti-fouling layer and arranged at an average interval (distance) of 1,000 nm or less.

The shapes of the convex portions and the concave portions are not particularly limited and can be appropriately selected depending upon the purpose. Examples of the shapes include cone-shaped, columnar, needle, a partially spherical shape (for example, semispherical shape), a partially ellipsoidal shape (for example, semi-ellipsoidal shape) and a polygonal shape. It is not necessary that these shapes are those completely satisfying mathematical definitions and may have distortion to some extent.

The convex portions or the concave portions are two-dimensionally arranged in the surface of the anti-fogging and anti-fouling layer. The convex portions or the concave portions may be regularly or randomly arranged. In the case of regular arrangement, the convex portions or the concave portions are most densely arranged.

The average distance between adjacent convex portions, which is not particularly limited and can be appropriately selected depending upon the purpose, is preferably 5 nm to 1,000 nm, more preferably 10 nm to 500 nm, and particularly preferably 50 nm to 300 nm.

The average distance between adjacent concave portions, which is not particularly limited and can be appropriately selected depending upon the purpose, is preferably 5 nm to 1,000 nm, more preferably 10 nm to 500 nm, and particularly preferably 50 nm to 300 nm.

If each of the average distance between adjacent convex portions and the average distance between adjacent concave portions falls within the preferable range, advantageously, the anti-fogging and anti-fouling laminate and the product of the present invention are excellent in anti-fogging property, abrasion resistance, and stain wiping property.

The average height of the convex portions, which is not particularly limited and can be appropriately selected depending upon the purpose, is preferably 1 nm to 1,000 nm, more preferably 5 nm to 500 nm, further preferably 10 nm to 300 nm, and particularly preferably 50 nm to 300 nm.

The average depth of the concave portions, which is not particularly limited and can be appropriately selected depending upon the purpose, is preferably 1 nm to 1,000 nm, more preferably 5 nm to 500 nm, further preferably 10 nm to 300 nm, and particularly preferably 50 nm to 300 nm.

If each of the average height of the convex portions and the average depth of the concave portions falls within the preferable range, transferability of the nanosized convexoconcave structure and releasability of the transfer matrix are excellent, and thus manufacture efficiency is good. Moreover, advantageously, the anti-fogging and anti-fouling laminate and the product of the present invention are excellent in anti-fogging property, abrasion resistance, and stain wiping property. When the height or the depth is too large, abrasion resistance and stain wiping property tend to be poor. When the height or the depth is too small, anti-fogging property tends to be poor.

The average aspect ratio (the average height of the convex portions/the average distance between adjacent convex portions) of the convex portions and the average aspect ratio (the average depth of the concave portions/the average distance of adjacent concave portions) of the concave portions, which are not particularly limited and can be appropriately selected depending upon the purpose, are each preferably 0.001 to 1,000, more preferably 0.1 to 10, and particularly preferably 0.2 to 1.0.

If each of the average aspect ratio of the convex portions and the average aspect ratio of the concave portions falls within the preferable range, transferability of the nanosized convexoconcave structure and releasability of the transfer matrix are excellent, and thus manufacture efficiency is good. Moreover, advantageously, the anti-fogging and anti-fouling laminate and the product of the present invention are excellent in anti-fogging property, abrasion resistance, and stain wiping property. When the aspect ratio is too large, abrasion resistance and stain wiping property tend to be poor. When the aspect ratio is too small, anti-fogging property tends to be poor.

The average distance (Pm) of convex portions or concave portions herein and the average height of convex portions or average depth (Hm) of concave portions can be determined as follows.

First, the surface S of the anti-fogging and anti-fouling layer having convex portions or concave portions is observed by an atomic force microscope (AFM). From a section profile by the AFM, the pitch of convex portions or concave portions, and the height of the convex portion or the depth of the concave portion are obtained. This procedure is repeated with respect to 10 sites randomly selected from the surface of the anti-fogging and anti-fouling layer to obtain pitch P1, P2, . . . , P10 and the height or to depth H1, H2, . . . , H10.

The pitch of the convex portions herein is the distance between the peaks of convex portions. The pitch of the concave portions is the distance between the deepest points of concave portions. The height of the convex portion is the height of the convex portion based on the lowest point of the valley portion between the convex portions. The depth of the concave portion is the depth of the concave portion based on the highest point of the mount portion between the concave portions.

Then, these pitches P1, P2, . . . , P10, and height or depth H1, H2, . . . , H10 are simply averaged (arithmetic average), respectively to obtain the average distance (Pm) of convex portions or concave portions, average height of convex portions or the average depth (Hm) of the concave portions.

Note that if the pitch of the convex portion or concave portion has in-plane anisotropy, the pitch in the direction giving a maximum value is used to obtain Pm. If the height of the convex portion or the depth of the concave portion has in-plane anisotropy, the height or depth in the direction giving a maximum value is used to obtain Hm.

If the convex portions or concave portions have rod shapes, the pitch in the minor axis direction is used as the pitch.

Note that in the AFM observation, in order for the convex peak or the bottom edge of the concave in a section profile to match the convex peak or the deepest portion of the concave portion of a three dimensional shape, the section profile is cut out in such a way that a cut line passes through the convex peak of the three dimensional shape to be measured or the deepest portion of the concave portion of the three dimensional shape.

Whether the micro structures formed in the surface of the anti-fogging and anti-fouling layer are convex portions or concave portions is determined as follows.

The surface S of the anti-fogging and anti-fouling layer having convex portions or concave portions is observed by an atomic force microscope (AFM), AFM images of the section and the surface S are obtained.

In the AFM image of the surface, the image in the most superficial side is obtained as a bright image, whereas the image of the deepest side is obtained as a dark image. If a bright image is formed like an island in a dark image, it is determined that the surface has a convex portion.

Conversely, if a dark image is formed like an island in a bright image, it is determined that the surface has a concave portion.

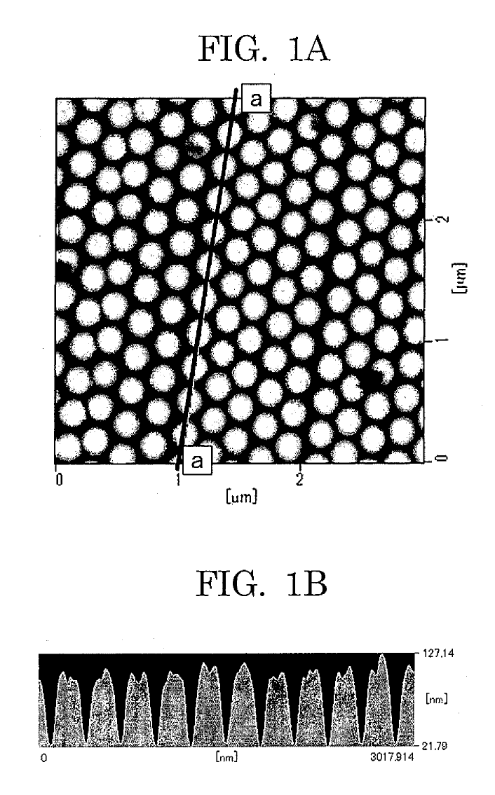

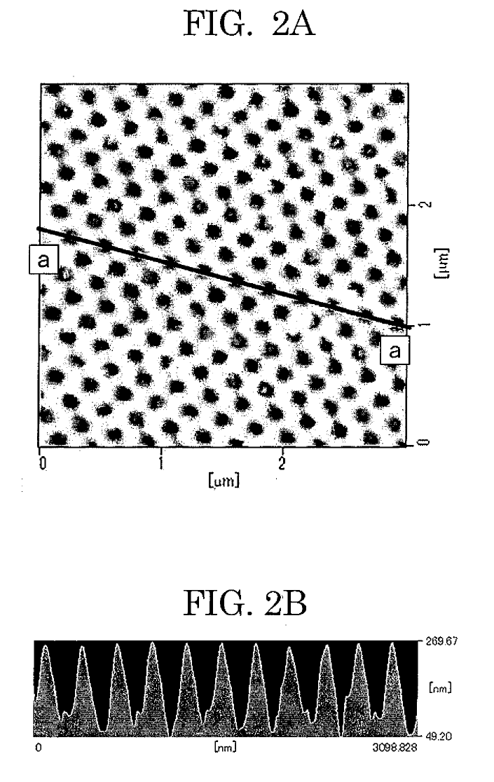

For example, the surface of an anti-fogging and anti-fouling layer providing AFM images of the surface and section shown in FIG. 1A and FIG. 1B, respectively, has convex portions. The surface of an anti-fogging and anti-fouling layer providing AFM images of the surface and section shown in FIG. 2A and FIG. 2B, respectively, has concave portions.

The average surface area ratio of the surface of the anti-fogging and anti-fouling layer, which is not particularly limited and can be appropriately selected depending upon the purpose, is preferably 1.1 or more, more preferably 1.3 or more, and particularly preferably 1.4 or more. The surface area ratio refers to a ratio of the surface area of an object in a predetermined region relative to the area of the predetermined region (surface area/area). When the average surface area ratio is large, moisture microparticles from, for example, exhalation are more easily incorporated into the anti-fogging and anti-fouling layer, which leads to improved anti-fogging property. This effect can widen options of the material for the anti-fogging and anti-fouling layer and achieve excellent anti-fogging property while increasing hardness of the anti-fogging and anti-fouling layer. The anti-fogging and anti-fouling laminate and the product of the present invention can have excellent anti-fogging property, heat and moisture resistance, abrasion resistance, and stain wiping property at the same time.

The average surface area ratio of the surface of the anti-fogging and anti-fouling layer herein can be measured as follows.

The surface S of the anti-fogging and anti-fouling layer having convex portions or concave portions is observed by an atomic force microscope (AFM), an AFM image of the surface S is obtained. This procedure is repeated with respect to 10 sites randomly selected from the surface of the anti-fogging and anti-fouling layer to obtain surface area S1, S2, . . . , S10. Next, the ratios of these surface areas S1, S2, . . . , S10 relative to the area of the corresponding observation areas (surface area/area) SR1, SR2, . . . , SR10 are simply averaged (arithmetic average) to obtain the average surface area ratio SRm of the surface of the anti-fogging and anti-fouling layer.

### —Pure Water Contact Angle—

The pure water contact angle of the surface of the anti-fogging and anti-fouling layer is 90° or more, preferably 100° or more, more preferably 110° or more, and particularly preferably 115° or more. The upper limit of the pure water contact angle, which is not particularly limited and can be appropriately selected depending upon the purpose, is, for example, 170°.

The pure water contact angle can be measured by the θ/2 method by use of, for example, PCA-1 (manufactured by Kyowa Interface Science Co., Ltd.) in the following conditions.
Distillation water is placed in a plastic syringe. To the tip of the syringe, a stainless steel needle is attached. The distillation water is allowed to drip on an evaluation surface.
The amount of water to be dripped: 2 μL
The measurement temperature: 25° C.

The contact angle 5 seconds after dripping of water is measured at randomly selected 10 points on the surface of the anti-fogging and anti-fouling layer, and the average value thereof is defined as the pure water contact angle.

### —Hexadecane Contact Angle—

The hexadecane contact angle of the surface of the anti-fogging and anti-fouling layer is preferably 60° or more, more preferably 70° or more, and particularly preferably 80° or more. The upper limit of the hexadecane contact angle, which is not particularly limited and can be appropriately selected depending upon the purpose, is, for example, 150°. If the hexadecane contact angle falls within the preferable range, advantageously, fingerprints, sebum, sweat, tear, cosmetics, etc. attached on the surface can be easily wiped, and excellent anti-fogging property can be maintained.

The hexadecane contact angle can be measured by the θ/2 method by use of PCA-1 (manufactured by Kyowa Interface Science Co., Ltd.) in the following conditions.
Hexadecane is placed in a plastic syringe. To the tip of the syringe, a TEFLON coated stainless steel needle is attached. The hexadecane is allowed to drip on an evaluation surface.
The amount of hexadecane to be dripped: 1 μL
The measurement temperature: 25° C.

The contact angle 20 seconds after dripping of hexadecane is measured at randomly selected 10 points on the surface of the anti-fogging and anti-fouling layer, and the average value thereof is defined as the hexadecane contact angle.

### —Active Energy Ray Curable Resin Composition—

The active energy ray curable resin composition is not particularly limited and can be appropriately selected depending upon the purpose. The active energy ray curable resin composition is, for example, an active energy ray curable resin composition containing at least a hydrophobic monomer, a hydrophilic monomer, and a photopolymerization initiator, and further containing other components as necessary.

The active energy ray curable resin composition preferably contains an organic compound having at least one of fluorine and silicon, since stain wiping property, abrasion resistance, and anti-fogging property are improved and releasability of the transfer matrix is excellent which leads to efficient manufacturing. Examples of such a compound include the following hydrophobic monomers.

### ——Hydrophobic Monomer——

Examples of the hydrophobic monomer include fluorine-containing (meth)acrylates and silicone (meth)acrylates. Specific examples thereof include (meth)acrylates containing a fluoroalkyl group, (meth)acrylates containing a fluoroalkyl ether group, and (meth)acrylates containing a dimethylsiloxane group.

The hydrophobic monomer is preferably compatible with the hydrophilic monomer.

In the present invention, the (meth)acrylate refers to an acrylate or a methacrylate. The same applies to (meth)acryloyl and (meth)acryl.

The hydrophobic monomer may be a commercially available product.

Examples of commercially available products of the fluorine-containing (meth)acrylates include KY-1200 series manufactured by Shin-Etsu Chemical Co., Ltd., MEGAFACE RS series manufactured by DIC CORPORATION, and OPTOOL DAC manufactured by DAIKIN INDUSTRIES, LTD.

Examples of commercially available products of the silicone (meth)acrylates include X-22-164 series manufactured by Shin-Etsu Chemical Co., Ltd. and TEGO Rad series manufactured by Evonik Co.

The content of the hydrophobic monomer in the active energy ray curable resin composition, which is not particularly limited and can be appropriately selected depending upon the purpose, is preferably 0.1% by mass to 5.0% by mass, more preferably 0.3% by mass to 2.0% by mass, and particularly preferably 0.5% by mass to 1.5% by mass. If the content is more than 5.0% by mass, the cured product is excellent in hydrophobicity but is low in the glass transition temperature. As a result, the cured product is too soft and may be reduced in abrasion resistance. Also, the anti-fogging and anti-fouling layer contains a large amount of reaction products of the hydrophobic monomer, which may lead to decreased anti-fogging property to exhalation.

The active energy ray curable resin composition preferably contains a compound having at least one of a polyoxyalkyl group and a polyoxyalkylene group since excellent anti-fogging property can be obtained. Examples of such a compound include the following polyoxyalkyl-containing (meth)acrylates. This compound has hydrophilicity and thus has water-absorbable property.

### ——Hydrophilic Monomer——

Examples of the hydrophilic monomer include a polyoxyalkyl-containing (meth)acrylate, a quaternary ammonium salt-containing (meth)acrylate, a tertiary amino group-containing (meth)acrylate, a sulfonic acid group-containing monomer, carboxylic acid group-containing monomer, phosphoric acid group-containing monomer and a phosphonic acid group-containing monomer.

Examples of the polyoxyalkyl-containing (meth)acrylate include mono- or poly-acrylates or mono- or poly-methacrylates obtained by the reaction between a polyhydric alcohol (polyol or polyhydroxy-containing compound) and a compound selected from the group consisting of an acrylic acid, a methacrylic acid and derivatives thereof. Examples of the polyhydric alcohol include divalent alcohols, trivalent alcohols and quadrivalent or larger valent alcohols. Examples of the divalent alcohols include ethylene glycol, diethylene glycol, triethylene glycol, tetraethylene glycol, polyethylene glycol having a number average molecular weight of 300 to 1,000, propylene glycol, dipropylene glycol, 1,3-propanediol, 1,4-butanediol, 1,5-pentanediol, 1,6-hexanediol, neopentyl glycol, 2-ethyl-1,3-hexanediol, 2,2′-thiodiethanol and 1,4-cyclohexanedimethanol. Examples of the trivalent alcohols include trimethylolethane, trimethylolpropane, pentaglycerol, glycerol, 1,2,4-butanetriol and 1,2,6-hexanetriol. Examples of the quadrivalent or larger valent alcohols include pentaerythritol, diglycerol and dipentaerythritol.

Examples of the polyoxyalkyl-containing (meth)acrylate include polyethylene glycol (meth)acrylate and polypropylene glycol (meth)acrylate. Examples of the polyethylene glycol (meth)acrylate include methoxy polyethylene glycol (meth)acrylate. The molecular weight of the polyethylene glycol unit of the polyethylene glycol (meth)acrylate, which is not particularly limited and can be appropriately selected depending upon the purpose, is for example, 300 to 1,000. As the methoxy polyethylene glycol (meth)acrylate, a commercially available product can be used. Examples of the commercially available product include MEPM-1000 (manufactured by Dai-ichi Kogyo Seiyaku Co., Ltd.).

Of them, polyethylene glycol (meth)acrylate is preferable and methoxy polyethylene glycol (meth)acrylate is more preferable.

Examples of the quaternary ammonium salt-containing (meth)acrylate include (meth)acryloyloxyethyltrimethylammonium chloride, (meth)acryloyloxyethyldimethylbenzylammonium chloride, (meth)acryloyloxyethyldimethylglycidylammonium chloride, (meth)acryloyloxyethyltrimethylammoniummethyl sulfate, (meth)acryloyloxydimethylethylammoniumethyl sulfate, (meth)acryloyloxyethyltrimethylammonium-p-toluene sulfonate, (meth)acrylamidepropyltrimethylammonium chloride, (meth)acrylamidepropyldimethylbenzylammonium chloride, (meth)acrylamidepropyldimethylglycidylammonium chloride, (meth)acrylamidepropyltrimethylammoniummethyl sulfate, (meth)acrylamidepropyldimethylethylammoniumethyl sulfate and (meth)acrylamidepropyltrimethylammonium-p-toluene sulfonate.

Examples of the tertiary amino group-containing (meth)acrylate include N,N-dimethylaminoethyl(meth)acrylate, N,N-dimethylaminopropyl(meth)acrylamide, diethylaminopropyl(meth)acrylamide, 1,2,2,6,6-pentamethylpiperidyl(meth)acrylate and 2,2,6,6-tetramethylpiperidyl(meth)acrylate.

Examples of the sulfonic acid group-containing monomer include vinylsulfonic acid, allylsulfonic acid, vinyltoluenesulfonic acid, styrenesulfonic acid and sulfonic acid group-containing (meth)acrylate. Examples of the sulfonic acid group-containing (meth)acrylate include sulfoethyl (meth)acrylate, sulfopropyl (meth)acrylate, 2-acrylamide-2-methylpropanesulfonic acid and terminal sulfonic acid modified polyethylene glycol mono(meth)acrylate. These may form salts. Examples of the salts include a sodium salt, a potassium salt, and an ammonium salt.

Examples of the carboxylic acid group-containing monomer include acrylic acid and methacrylic acid.

Examples of the phosphoric acid group-containing monomer include (meth)acrylate having a phosphoric acid ester.

The hydrophilic monomer is preferably a monofunctional hydrophilic monomer.

The molecular weight of the hydrophilic monomer, which is not particularly limited and can be appropriately selected depending upon the purpose, is preferably 200 or more.

The content of the hydrophilic monomer in the active energy ray curable resin composition, which is not particularly limited and can be appropriately selected depending upon the purpose, is preferably 15% by mass to 99.9% by mass, more preferably 20% by mass to 90% by mass, and particularly preferably 25% by mass to 50% by mass.

In place of the hydrophilic monomer, a polymer to which one or more photosensitive groups selected from an azido group, a phenyl azido group, a quinone azido group, a stilbene group, a chalcone group, a diazonium base, a cinnamon acid group and an acrylic acid group are introduced, may be used. Examples of the polymer include a polyvinyl alcohol polymer, a polyvinylbutyral polymer, a polyvinylpyrrolidone polymer, a polyacrylamide polymer, a polyvinyl acetate polymer and a polyoxyalkylene polymer.

### ——Photopolymerization Initiator——

Examples of the photopolymerization initiator include a photoradical polymerization initiator, a photo-acid generating agent, a bisazido compound, hexamethoxymethylmelamine and tetramethoxy glycoluril.

Examples of the photoradical polymerization initiator, which is not particularly limited and can be appropriately selected depending upon the purpose, include ethoxyphenyl(2, 4, 6-trimethylbenzoyl)phosphine oxide, bis(2, 6-dimethylbenzoyl)-2,4,4-trimethylpentylphosphine oxide, bis(2,4,6-trimethylbenzoyl)-2,4,4-trimethylpentylphosphine oxide, bis(2,6-dichlorobenzoyl)-2,4,4-trimethylpentylphosphine oxide, 1-phenyl-2-hydroxy-2-methylpropan-1-on, 1-hydroxycyclohexylphenyl ketone, 1-(4-isopropylphenyl)-2-hydroxy-2-methylpropan-1-on, 1,2-diphenylethanedione and methylphenylglyoxylate.

The content of the photopolymerization initiator in the active energy ray curable resin composition, which is not particularly limited and can be appropriately selected depending upon the purpose, is preferably 0.1% by mass to 10% by mass, more preferably 0.5% by mass to 8% by mass, and particularly preferably 1% by mass to 5% by mass.

### ——Other Components——

Examples of the other components, which are not particularly limited and can be appropriately selected depending upon the purpose, include urethane (meth)acrylate, an isocyanuric acid group-containing (meth)acrylate and a filler.

These are sometimes used for controlling elongation percentage and hardness, etc. of the anti-fogging and anti-fouling layer.

Examples of the urethane (meth)acrylate, which is not particularly limited and can be appropriately selected depending upon the purpose, include an aliphatic urethane (meth)acrylate and an aromatic urethane (meth)acrylate. Of them, an aliphatic urethane (meth)acrylate is preferable.

The content of the urethane (meth)acrylate in the active energy ray curable resin composition, which is not particularly limited and can be appropriately selected depending upon the purpose, is preferably 10% by mass to 45% by mass, more preferably 15% by mass to 40% by mass, and particularly preferably 20% by mass to 35% by mass.

Examples of the isocyanuric acid group-containing (meth)acrylate, which is not particularly limited and can be appropriately selected depending upon the purpose, include an ethoxylated isocyanuric acid (meth)acrylate. Of them, an ethoxylated isocyanuric acid (meth)acrylate is preferable.

The content of the isocyanuric acid group-containing (meth)acrylate in the active energy ray curable resin composition, which is not particularly limited and can be appropriately selected depending upon the purpose, is preferably 10% by mass to 45% by mass, more preferably 15% by mass to 40% by mass, and particularly preferably 20% by mass to 35% by mass.

Examples of the filler, which is not particularly limited and can be appropriately selected depending upon the purpose, include silica, zirconia, titania, tin oxide, indium tin oxide, antimony-doped tin oxide and antimony pentoxide. Examples of the silica include solid silica and hollow silica.

The active energy ray curable resin composition is diluted with an organic solvent and put in use. Examples of the organic solvent include an aromatic solvent, an alcohol solvent, an ester solvent, a ketone solvent, a glycol ether solvent, a glycol ether ester solvent, a chlorine solvent, an ether solvent, N-methylpyrrolidone, dimethylformamide, dimethylsulfoxide and dimethylacetamide.

The active energy ray curable resin composition is cured by irradiation of an active energy ray. Examples of the active energy ray, which is not particularly limited and can be appropriately selected depending upon the purpose, include an electron beam, a UV ray, an infrared ray, a laser beam, a visible ray, ionizing radiation (X ray, an a ray, a β ray, a γ ray, etc.), a microwave and a high-frequency wave.

The Martens hardness of the anti-fogging and anti-fouling layer, which is not particularly limited and can be appropriately selected depending upon the purpose, is preferably 20 N/mm² to 300 N/mm², more preferably 50 N/mm² to 290 N/mm², and particularly preferably 50 N/mm² to 280 N/mm². In molding process of the anti-fogging and anti-fouling laminate, more specifically, in injection molding of a polycarbonate, an anti-fogging and anti-fouling laminate is heated and pressed at 290° C. and at a pressure of 200 MPa. At this time, micro convex portions or micro concave portions in the surface of the anti-fogging and anti-fouling layer sometimes deform. For example, the height of the micro convex portions decreases and the depth of micro concave portions decreases. Deformation is acceptable as long as the anti-fogging performance is not affected; however, if deformation is excessively large, anti-fogging performance sometimes deteriorates. If the Martens hardness is less than 20 N/mm², micro convex portions or micro concave portions in the surface of the anti-fogging and anti-fouling layer is excessively deformed in a molding process of the anti-fogging and anti-fouling laminate, anti-fogging performance sometimes deteriorates. In addition, the anti-fogging and anti-fouling layer is easily cracked in handling during a production or molding process of the anti-fogging and anti-fouling laminate and in surface cleaning during ordinary use. In contrast, if the Martens hardness exceeds 300 N/mm², the anti-fogging and anti-fouling layer is sometimes cracked and peels during a molding process. It is advantageous that the Martens hardness falls within the particularly preferable range, since the anti-fogging and anti-fouling laminate can be easily molded into various three-dimensional shapes without deteriorating anti-fogging performance and without producing defects such as a scratch, a crack, and peeling.

Note that after the molding process of the anti-fogging and anti-fouling laminate, since high temperature and high pressure are applied to the anti-fogging and anti-fouling layer in the injection molding step, the Martens hardness of the anti-fogging and anti-fouling layer sometimes increases than before the molding process.

The Martens hardness can be measured, for example, by means of PICODENTOR HM500 (trade name; manufactured by Fischer Instruments K.K.) by applying a load (1 mN/20 s) and using a diamond cone as a needle, at a face angle of 136°.

The pencil hardness of the anti-fogging and anti-fouling layer, which is not particularly limited and can be appropriately selected depending upon the purpose, is preferably B to 4H, more preferably HB to 4H, and particularly preferably F to 4H. If the pencil hardness is less than B (softer than B), the anti-fogging and anti-fouling layer is easily cracked in handling during a production or molding process of the anti-fogging and anti-fouling laminate and in surface cleaning during ordinary use. In addition, in a molding process of the anti-fogging and anti-fouling laminate, micro convex portions or micro concave portions in the surface of the anti-fogging and anti-fouling layer excessively deforms, with the result that pure water contact angle increases and anti-fogging performance sometimes deteriorates. In contrast, if the pencil hardness exceeds 4H (harder than 4H), the anti-fogging and anti-fouling layer sometimes cracks and peels during a molding process. It is advantageous that the pencil hardness falls within the particularly preferable range, since the anti-fogging and anti-fouling laminate can be easily molded into various three-dimensional shapes without deteriorating anti-fogging performance and without producing defects such as a scratch, a crack, and peeling.

Note that after the molding process of the anti-fogging and anti-fouling laminate, since high temperature and high pressure are applied to the anti-fogging and anti-fouling layer in the injection molding step, the pencil hardness of the anti-fogging and anti-fouling layer sometimes increases than before the molding process.

The pencil hardness is measured in accordance with JIS K 5600-5-4.

The average thickness of the anti-fogging and anti-fouling layer, which is not particularly limited and can be appropriately selected depending upon the purpose, is preferably 1 μm to 100 μm, more preferably 1 μm to 50 μm, and particularly preferably 1 μm to 30 μm.

### <Other Members>

As other members, an anchor layer, a protective layer, etc. are mentioned.

### —Anchor Layer—

The anchor layer is a layer which is provided between the substrate made of a resin and the anti-fogging and anti-fouling layer.

Owing to the presence of the anchor layer, adhesion between the substrate made of a resin and the anti-fogging and anti-fouling layer can be improved.

The refractive index of the anchor layer is preferably close to the refractive index of the anti-fogging and anti-fouling layer in order to prevent interference irregularity. For this reason, the refractive index of the anchor layer falls preferably within ±0.10 of the refractive index of the anti-fogging and anti-fouling layer and more preferably within ±0.05. Alternatively, the refractive index of the anchor layer is preferably between the refractive index of the anti-fogging and anti-fouling layer and the refractive index of the substrate made of a resin.

The anchor layer can be formed by applying, for example, an active energy ray curable resin composition. As the active energy ray curable resin composition, for example, an active energy ray curable resin composition containing at least urethane (meth)acrylate and a photopolymerization initiator, and further containing other components as necessary is mentioned. As the urethane (meth)acrylate and the photopolymerization initiator, the same examples of the urethane (meth)acrylates and the photopolymerization initiators as described in the section where the anti-fogging and anti-fouling layer is described, are respectively mentioned. Examples of the application method for coating, which is not particularly limited and can be appropriately selected depending upon the purpose, include wire bar coating, blade coating, spin coating, reverse roll coating, die coating, spray coating, roll coating, gravure coating, microgravure coating, lip coating, air knife coating, curtain coating, a comma coat method and a dipping method.

The average thickness of the anchor layer, which is not particularly limited and can be appropriately selected depending upon the purpose, is preferably 0.01 μm to 10 μm, more preferably 0.1 μm to 5 μm, and particularly preferably 0.3 μm to 3 μm.

Note that a reflectivity-reducing function and an antistatic function may be imparted to the anchor layer.

### —Protective Layer—

The protective layer is a layer to protect the surface of the anti-fogging and anti-fouling layer (the surface where the pure water contact angle is 90° or more).

The protective layer protects the surface when manufacturing the below-described product using the anti-fogging and anti-fouling laminate.

The protective layer is formed on the surface of the anti-fogging and anti-fouling layer.

Examples of the material for the protective layer include similar materials to those for the anchor layer.

The elongation percentage of the anti-fogging and anti-fouling laminate, which is not particularly limited and can be appropriately selected depending upon the purpose, is preferably 10% or more, more preferably 10% to 200% and particularly preferably 40% to 150%. If the elongation percentage is less than 10%, it is sometimes difficult to perform molding processing. It is advantageous that the elongation percentage falls within the particularly preferable range since molding processability is excellent.

The elongation percentage is obtained, for example, by the following method.

The anti-fogging and anti-fouling laminate is cut into rectangular pieces of 10.5 cm in length×2.5 cm in width and used as measurement samples. The tension-elongation percentage of the measurement samples obtained is measured by a tension-tester (autograph AG-5kNX plus, manufactured by Shimadzu Corporation) in measurement conditions (tension rate=100 mm/min; distance between chucks=8 cm). In measurement of the elongation percentage, measurement temperature varies depending upon the type of resin constituting a substrate. The elongation percentage is measured at a temperature near the softening point of the substrate made of a resin or the softening point or more, more specifically, a temperature between 10° C. to 250° C. For example, if the resin substrate is made of polycarbonate or a PC/PMMA laminate, the elongation percentage is preferably measured at 150° C.

It is preferable that the anti-fogging and anti-fouling laminate has a small difference in rate of in-plane heat shrinkage between the X direction and the Y direction. The X direction and the Y direction of the anti-fogging and anti-fouling laminate are defined as follows. For example, if the anti-fogging and anti-fouling laminate is a roll, the X direction and the Y direction correspond to the longitudinal direction and the width direction of the roll, respectively. It is preferable that the difference in rate of heat shrinkage between the X direction and the Y direction of the anti-fogging and anti-fouling laminate at the heating temperature employed in the heating step during molding, falls within 5%. If the difference is outside the range, the anti-fogging and anti-fouling layer is peeled and cracked during a molding process, and letters, patterns and images printed on the surface of a substrate made of a resin deform or shift in position, with the result that it becomes sometime difficult to apply a molding process.

The anti-fogging and anti-fouling laminate is a film particularly suitable for in-mold forming, insert molding, and overlay.

As a method for manufacturing the anti-fogging and anti-fouling laminate, which is not particularly limited and can be appropriately selected depending upon the purpose, a method for manufacturing the anti-fogging and anti-fouling laminate of the present invention (described later) is preferable.

### (Method for Manufacturing Anti-Fogging and Anti-Fouling Laminate)

A method for manufacturing the anti-fogging and anti-fouling laminate of the present invention includes at least: an uncured resin layer forming step, and a anti-fogging and anti-fouling layer forming step; and further includes other steps as necessary.

The method for manufacturing the anti-fogging and anti-fouling laminate is a method for manufacturing the anti-fogging and anti-fouling laminate of the present invention.

### <Uncured Resin Layer Forming Step>

The uncured resin layer forming step is not particularly limited and can be appropriately selected depending upon the purpose, as long as the step is a step of applying an active energy ray curable resin composition to a substrate made of a resin to form an uncured resin layer.

Examples of the substrate made of a resin, which is not particularly limited and can be appropriately selected depending upon the purpose, include examples of the substrate made of a resin described in the section where the anti-fogging and anti-fouling laminate of the present invention is described.

Examples of the active energy ray curable resin composition, which is not particularly limited and can be appropriately selected depending upon the purpose, include examples of the active energy ray curable resin composition described in the section where the anti-fogging and anti-fouling layer for the anti-fogging and anti-fouling laminate of the present invention is described.

The uncured resin layer is formed by applying the active energy ray curable resin composition to the substrate made of a resin and drying the composition as necessary. The uncured resin layer may be a solid film or a film having flowability due to a curable component of low molecular weight contained in the active energy ray curable resin composition.

Examples of the application method for coating, which is not particularly limited and can be appropriately selected depending upon the purpose, include wire bar coating, blade coating, spin coating, reverse roll coating, die coating, spray coating, roll coating, gravure coating, microgravure coating, lip coating, air knife coating, curtain coating, a comma coat method and a dipping method.

The uncured resin layer remains uncured since the layer is not irradiated with an active energy ray.

In the uncured resin layer forming step, if an anchor layer is formed on the substrate made of a resin, the active energy ray curable resin composition may be applied to the anchor layer to form the uncured resin layer.

Examples of the anchor layer, which is not particularly limited and can be appropriately selected depending upon the purpose, include examples of the anchor layers described in the section where the anti-fogging and anti-fouling laminate of the present invention is described.

### <Anti-Fogging and Anti-Fouling Layer Forming Step>

The anti-fogging and anti-fouling layer forming step is not particularly limited and can be appropriately selected depending upon the purpose as long as the step is a step of forming an anti-fogging and anti-fouling layer by bringing a transfer matrix having micro convex portions or micro concave portions into contact with the uncured resin layer, and irradiating the uncured resin layer in contact with the transfer matrix with an active energy ray to cure the uncured resin layer, thereby transferring the micro convex portions or the micro concave portions.

### —Transfer Matrix—

The transfer matrix has micro convex portions or micro concave portions.

The material, size and structure of the transfer matrix are not particularly limited and can be appropriately selected depending upon the purpose.

A method for forming micro convex portions or micro concave portions of the transfer matrix, which is not particularly limited and can be appropriately selected depending upon the purpose, is preferably etching of the surface of the transfer matrix with a photoresist having predetermined pattern shape used as a protective film, or laser processing of the transfer matrix by irradiating the surface of the transfer matrix with a laser.

The surface of the transfer matrix to be brought into contact with the uncured resin layer is preferably treated with a compound containing at least one of fluorine and silicon (hereinafter this treatment may be referred to as a “surface-energy-lowering treatment”). This treatment makes it possible to lower the surface energy of the transfer matrix. When the transfer matrix is brought into contact with the uncured resin layer, the low-surface-energy components (e.g., the organic compound containing at least one of fluorine and silicon) are localized in the uncured resin layer at the side of the surface of the transfer matrix. The pure water contact angle of the surface of the transfer matrix after subjected to the surface-energy-lowering treatment is preferably 90° or more. If it falls within this range, the organic compound containing at least one of fluorine and silicon is effectively localized in the uncured resin layer at the side of the surface of the transfer matrix when the transfer matrix and the uncured resin layer are brought into contact with each other.

The pure water contact angle can be measured by the θ/2 method by use of, for example, PCA-1 (manufactured by Kyowa Interface Science Co., Ltd.) in the following conditions.
Distillation water is placed in a plastic syringe. To the tip of the syringe, a stainless steel needle is attached. The distillation water is allowed to drip on an evaluation surface.
The amount of water to be dripped: 2 μL
The measurement temperature: 25° C.

The contact angle 5 seconds after dripping of water is measured at randomly selected 10 points on the surface of the transfer matrix, and the average value thereof is defined as the pure water contact angle.

Examples of the compound containing at least one of fluorine and silicon used in the surface-energy-lowering treatment include metal alkoxides having a fluoroalkyl group, a fluoroalkylether group, or a dimethylsiloxane group. Examples of the metal alkoxides include Si alkoxides, Ti alkoxides, and Al alkoxides.

The surface-energy-lowering treatment can be performed by, for example, immersing the transfer matrix in liquid containing the compound containing at least one of fluorine and silicon, and then heating.

The time for which the transfer matrix is immersed in the liquid is not particularly limited and can be appropriately selected depending upon the purpose.

The temperature and the time in the heating are not particularly limited and can be appropriately selected depending upon the purpose.

When the active energy ray curable resin composition contains the organic compound containing at least one of fluorine and silicon (e.g., the hydrophobic monomer) and the compound containing at least one of the polyoxyalkyl group and the polyoxyalkylene group (e.g., the hydrophilic monomer) and the transfer matrix subjected to the surface-energy-lowering treatment is used, the low-surface-energy components are localized in the surface of the obtained anti-fogging and anti-fouling layer, and the hydrophilic components (water-absorbable components) are present inside the anti-fogging and anti-fouling layer. As a result, water droplets are easily repelled on the surface of the anti-fogging and anti-fouling layer, and water moisture is easily trapped inside the anti-fogging and anti-fouling layer, which results in more excellent anti-fogging property.

### —Active Energy Ray—

The active energy ray is not particularly limited and can be appropriately selected depending upon the purpose, as long as the uncured resin layer can be cured by the active energy ray. Examples of the active energy ray include those described in the section where the anti-fogging and anti-fouling laminate of the present invention is described.

Herein, specific examples of the anti-fogging and anti-fouling layer forming step will be described with reference to drawings.

### First Embodiment

The first embodiment is directed to an anti-fogging and anti-fouling layer forming step performed by using a transfer matrix having micro convex portions or micro concave portions which are formed by etching a surface of the transfer matrix with a photoresist having a predetermined pattern shape used as a protective film.

First, a transfer matrix and a method for manufacturing the transfer matrix will be described.

### [Structure of Transfer Matrix]

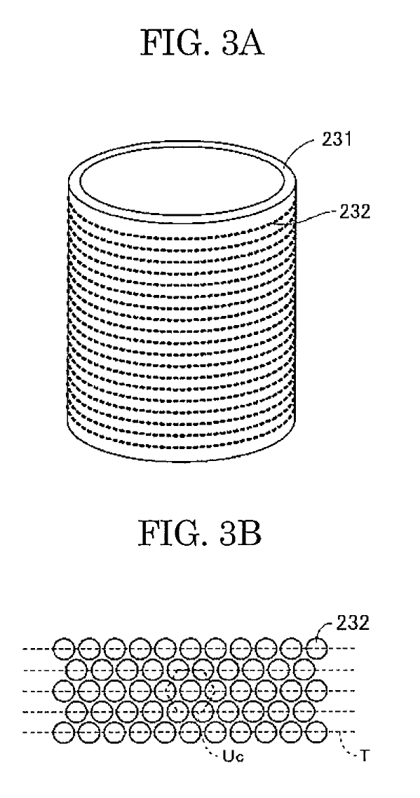

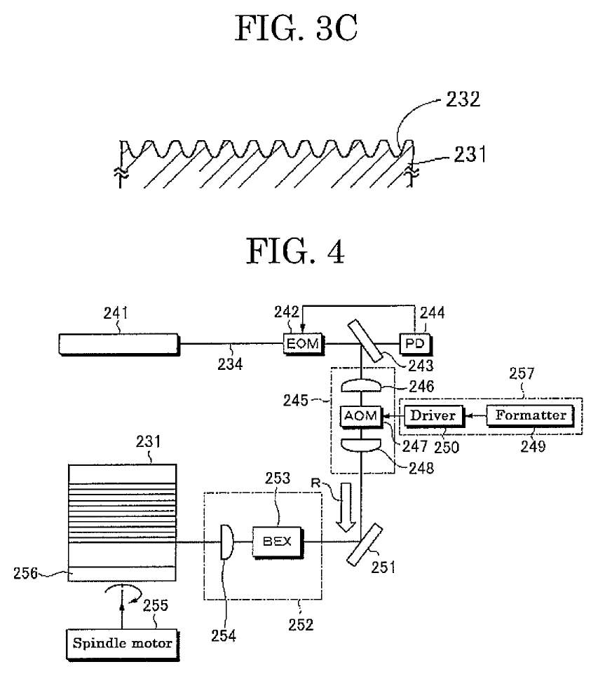

FIG. 3A is a perspective view showing a structure of a roll matrix serving as a transfer matrix. FIG. 3B is an enlarged plan view of a part of the roll matrix shown in FIG. 3A. FIG. 3C is a cross sectional view taken along the line of track T in FIG. 3B. A roll matrix 231 is a transfer matrix for use in preparing an anti-fogging and anti-fouling laminate having the aforementioned constitution, and more specifically is a matrix for molding a plurality of convex portions or concave portions in the surface of the anti-fogging and anti-fouling layer. The roll matrix 231 has, for example, a columnar or cylindrical shape and the columnar surface or cylinder surface serves as a molding surface for forming a plurality of convex portions or concave portions on the surface of an anti-fogging and anti-fouling layer. In the molding surface, for example, a plurality of structures 232 are two-dimensionally arranged. In FIG. 3C, the structure 232 has a concave state relative to the molding surface. As the material for the roll matrix 231, for example, glass can be used; however the material is not particularly limited to glass.

A plurality of structures 232 arranged in the molding surface of the roll matrix 231 and a plurality of convex portions or concave portions arranged in the surface of the anti-fogging and anti-fouling layer have mutually inverted convexoconcave patterns. To be more specific, the array, size, shape, arrangement pitch, height or depth and aspect ratio, etc. of the structures 232 of the roll matrix 231 are identical with those of the convex portions or concave portions of the anti-fogging and anti-fouling layer.

### [Roll-Matrix Exposure Apparatus]

FIG. 4 is a schematic view showing a structure of a roll-matrix exposure apparatus for preparing a roll matrix. The roll-matrix exposure apparatus is constituted based on an optical disk recording apparatus.

A laser beam source 241 is a light source for exposing with light a resist applied to the surface of the roll matrix 231 as a recording medium. The source 241 emits, for example, a laser beam 234 having a wavelength of λ=266 nm, for recording. The laser beams 234 emitted from the laser beam source 241 linearly proceed while maintaining parallel state, and enter an electro optical modulator (EOM) 242. The laser beam 234 passed through the electro optical modulator 242 is reflected by a mirror 243 and guided into an optical modulation system 245.

The mirror 243, which is constituted of a polarization beam splitter, has a function of reflecting one of polarized components and transmitting the other polarized component. The polarized component passed through the mirror 243 is received by a photodiode 244. The electro optical modulator 242 is controlled based on the received signal to perform phase modulation of the laser beam 234.

In the optical modulation system 245, the laser beam 234 is collected via a condensing lens 246 by an acousto-optic modulator (AOM) 247 formed of glass (SiO₂), etc. The laser beam 234 is modified in intensity by the acousto-optic modulator 247 and emitted, and then, changed into parallel beams by a lens 248. The laser beam 234 emitted from the optical modulation system 245 is reflected by a mirror 251 and guided onto a movable optical table 252 horizontally in parallel.

The movable optical table 252 has a beam expander 253 and an objective lens 254. The laser beam 234 guided to the movable optical table 252 is shaped into a desired beam shape by the beam expander 253, and emitted via the objective lens 254 to the resist layer on the roll matrix 231. The roll matrix 231 is placed on a turn table 256 connected to a spindle motor 255. While rotating the roll matrix 231 and simultaneously moving the laser beam 234 in the height direction of the roll matrix 231, to the resist layer formed on the peripheral side surface of the roll matrix 231 is intermittently irradiated with the laser beam 234. In this manner, a step of exposing the resist layer with light is carried out. The formed latent image has a substantially s1 ellipsoid shape having a major axis along the circumferential direction. The laser beam 234 is moved by moving the movable optical table 252 in the direction indicated by arrow R.

The light exposure apparatus has a control mechanism 257 for forming latent images corresponding to a two-dimensional pattern of the aforementioned convex portions or concave portions, on the resist layer. The control mechanism 257 has a formatter 249 and a driver 250. The formatter 249 has a polarity reversion portion. The polarity reversion portion controls application timing of the laser beam 234 to the resist layer. The driver 250 controls the acousto-optic modulator 247 in response to output of the polarity reversion portion.

In the roll-matrix exposure apparatus, so as to spatially link the two-dimensional patterns, a signal is generated track by track by operating the polarity reversion formatter in synchronism with a rotation controller. In this manner, the intensity is modified by the acousto-optic modulator 247. Patterning is performed at a constant angular velocity (CAV), an appropriate rotation number, an appropriate modulation frequency and an appropriate feed pitch. In this manner, a two-dimensional pattern such as a hexagonal lattice pattern can be recorded.

### [Resist Film Formation Step]

First, as shown in the cross sectional view of FIG. 5A, a columnar or cylindrical roll matrix 231 is prepared. The roll matrix 231 is, for example, a glass matrix. Next, as shown in the cross sectional view of FIG. 5B, a resist layer (for example, photoresist) 233 is formed on the surface of the roll matrix 231. Examples of the material for the resist layer 233 include organic resists and inorganic resists. Examples of the organic resists include a Novolak resist and a chemical amplification resist. Examples of the inorganic resist include metal compounds.

### [Light Exposure Step]

Next, as shown in the cross sectional view of FIG. 5C, the resist layer 233 formed on the surface of the roll matrix 231 is irradiated with the laser beam (light exposure beam) 234. To describe more specifically, on the turn table 256 of the roll-matrix exposure apparatus shown in FIG. 4, the roll matrix 231 is placed. The roll matrix 231 is rotated; at the same time, the resist layer 233 is irradiated with the laser beam (light exposure beam) 234. At this time, the resist layer is intermittently irradiated with the laser beam 234 while moving the laser beam 234 in the height direction (direction in parallel to the center axis of the columnar or cylindrical roll matrix 231) of the roll matrix 231 to expose the entire surface of the resist layer 233 with light. In this manner, latent images 235 are formed over the entire surface of the resist layer 233 in accordance with the track of the laser beam 234.

The latent images 235 are arranged so as to form, for example, a plurality of tracks T in the roll matrix surface; at the same time, a periodical pattern of a predetermined unit cell Uc is formed. Each of the latent images 235 has, for example, a circular or elliptical shape. If the latent image 235 has an elliptical shape, it is preferable that the elliptical shape has a major axis in parallel in the extension direction of track T.

### [Development Step]

Next, for example, while rotating the roll matrix 231, a developer is dripped to onto the resist layer 233 to develop the resist layer 233. In this manner, as shown in the cross sectional view of FIG. 5D, a plurality of opening portions are formed in the resist layer 233. If the resist layer 233 is formed of a positive-type resist, the light exposure portion exposed to the laser beam 234 is increased in dissolution rate to the developer compared to non-light exposure portion. As a result, as shown in the cross sectional view of FIG. 5D, the pattern reflecting the latent images (light exposure portion) 235 is formed on the resist layer 233. The pattern reflecting the opening portions is, for example, a pattern where a predetermined unit cell Uc regularly and periodically appears.

### [Etching Step]

Next, the surface of the roll matrix 231 is etched with the pattern (resist pattern) of the resist layer 233 formed on the roll matrix 231 used as a mask. In this manner, a cone-shaped structure (concave portion) 232 can be obtained as shown in the cross sectional view of FIG. 5E. The cone shape is preferably an elliptical cone shape or a truncated elliptical cone shape having a major axis, for example, in parallel to the extending direction of track T. As the etching, for example, dry etching and wet etching can be used. At this time, if an etching process and an ashing process are alternately performed, for example, a pattern of the cone-shaped structure 232 can be formed. In the manner mentioned above, the desired roll matrix 231 can be obtained.

Next, if necessary, the surface-energy-lowering treatment is performed. This makes it possible to lower the surface energy of the surface of the roll matrix 231.

### [Transfer Treatment]

As shown in the cross sectional view of FIG. 6A, a substrate 211 made of a resin having an uncured resin layer 236 formed thereon is prepared.

Next, as shown in the cross sectional view of FIG. 6B, the roll matrix 231 is to brought into contact with the uncured resin layer 236 formed on the substrate 211 made of a resin. The uncured resin layer 236 is irradiated with an active energy ray 237 to cure the uncured resin layer 236. In this manner, micro convex portions or micro concave portions is transferred to obtain an anti-fogging and anti-fouling layer 212 having micro convex portions or micro concave portions 212a formed therein.

Finally, the obtained anti-fogging and anti-fouling layer 212 is removed from the roll matrix 231 to obtain an anti-fogging and anti-fouling laminate (FIG. 6C).

Note that if the substrate 211 made of a resin is formed of a material which cannot transmit an active energy ray such as ultraviolet rays, it is possible that the roll matrix 231 is formed of a material which can transmit an active energy ray (for example, quartz) and the uncured resin layer 236 is irradiated with an active energy ray from the interior portion of the roll matrix 231. Note that the transfer matrix is not limited to the aforementioned roll matrix 231 and a flat plate-form matrix may be used. However, in view of increasing the amount of production, the aforementioned roll matrix 231 is preferably used as a transfer matrix.

### Second Embodiment

The second embodiment is directed to the anti-fogging and anti-fouling layer forming step performed by using a transfer matrix having micro convex portions or micro concave portions which are formed by laser processing of the transfer matrix by irradiating the surface of the transfer matrix with the laser.

First, a transfer matrix and a method for manufacturing the transfer matrix will be described.

### [Structure of Transfer Matrix]

FIG. 7A is a plan view showing a structure of a plate-form matrix. FIG. 7B is a cross sectional view taken long the line a-a, shown in FIG. 7A. FIG. 7C is an enlarged cross sectional view of a part of the section shown in FIG. 7B. A plate-form matrix 331 is a matrix for use in preparing an anti-fogging and anti-fouling laminate having the aforementioned constitution, more specifically, a matrix for molding a plurality of convex portions or concave portions in the surface of the anti-fogging and anti-fouling layer. The plate-form matrix 331 has a surface having, for example, a micro convexoconcave structure formed therein, and the surface serves as a molding surface for forming a plurality of convex portions or concave portions in the surface of an anti-fogging and anti-fouling layer. In the molding surface, for example, a plurality of structures 332 are provided. The structure 332 shown in FIG. 7C has a concave state relative to the molding surface. As the material for the plate-form matrix 331, for example, a metal material can be used. Examples of the metal material that can be used include Ni, NiP, Cr, Cu, Al, Fe and its alloy. As the alloy, stainless steel (SUS) is preferable. Examples of the stainless steel (SUS) include, but not limited to, SUS304 and SUS420J2.

A plurality of structures 332 provided in the molding surface of the plate-form matrix 331 and a plurality of convex portions or concave portions provided in the surface of the anti-fogging and anti-fouling layer have mutually inverted convexoconcave patterns. More specifically, the array, size, shape, arrangement pitch and height or depth etc. of the structures 332 of the plate-form matrix 331 are the same as those of the convex portions or concave portions of the anti-fogging and anti-fouling layer.

### [Structure of Laser Processing Apparatus]

FIG. 8 is a schematic view showing a structure of a laser processing apparatus for preparing a plate-form matrix. The laser main-body 340 is, for example, IFRIT (trade name, manufactured by Cyber Laser Inc.). The wavelength of the laser to be used for laser processing is, for example, 800 nm; however, the wavelength may be 400 nm and 266 nm etc. The repetitive frequency is preferably large in consideration of processing time and reducing the arrangement pitch between concave portions or convex portions formed, and preferably 1,000 Hz or more. The pulse width of the laser is preferably short, and preferably about 200 femto-seconds (10-15 seconds) to 1 pico-second (10⁻¹² seconds).

The laser main-body 340 emits laser beams linearly polarized in the vertical direction. Thus, in this apparatus, linearly polarized light in a desired direction or a circular polarized light is obtained by rotating the polarization direction by use of a wave plate 341 (for example, λ/2 wave plate). Furthermore, in this apparatus, a laser beam is partially taken out by use of an aperture 342 having a square opening, for the reason that since the intensity distribution of laser beam follows the Gaussian distribution, if the center portion of the laser beams alone is used, a laser beam having a uniform in-plane intensity distribution is obtained. Moreover, in the apparatus, the laser beam is narrowed by use of two cylindrical lenses 343 mutually perpendicularly placed to obtain a desired beam size. In processing the plate-form matrix 331, a linear stage 344 is moved at the same speed.

The beam spot of the laser with which the plate-form matrix 331 is irradiated preferably has a square shape. The beam spot can be shaped, for example, by use of an aperture and a cylindrical lens etc. Furthermore, the intensity distribution of the beam spot is preferably as uniform as possible. This is because the in-plane distribution of the depth of convexoconcave portions to be formed in dies is obtained as uniform as possible. Generally, since the size of a beam spot is smaller than the area to be processed, it is necessary to scan the beam to form convexoconcave portions in the entire surface that is desired to be processed.

The matrix (die) for use in forming the surface of the anti-fogging and anti-fouling layer is formed by irradiating a substrate made of a metal such as SUS, NiP, Cu, Al and Fe with an ultrashort pulsed-laser beam having a pulse width of 1 pico-second (10⁻¹² seconds) or less called a femto second laser to draw a pattern. Polarization of a laser beam may be linear, circular or ellipsoidal. At this time, the laser wavelength, repetitive frequency, pulse width, beam-spot shape, polarization, the intensity of a laser with which a sample is irradiated and laser scanning speed, etc., are appropriately set. In this manner, a pattern having desired convexoconcave portions can be formed.

As the parameters that can be changed in order to obtain a desired shape, the following ones are mentioned. Fluence refers to the energy density (J/cm²) per pulse and can be obtained in accordance with the following expression:

F=P/(fREPT×S)

where

S=Lx×Ly

F: Fluence

P: Power of laser

fREPT: Repetitive frequency of laser

S: Area of laser at irradiation position

Lx×Ly: Beam size

Note that the pulse number N is the number of pulses with which a single site is irradiated and obtained in accordance with the following expression.

N=fREPT×Ly/v

where

Ly: Beam size of a laser in a scanning direction

v: Scanning speed of laser

To obtain a desired shape, the material of the plate-form matrix 331 may be changed. Depending upon the material for the plate-form matrix 331, the shape processed by a laser changes. Other than the use of a metal such as SUS, NiP, Cu, Al and Fe, a matrix surface may be coated with, for example, a semiconductor material such as DLC (diamond-like carbon). As a method for coating a matrix surface with the semiconductor material, for example, plasma CVD and sputtering are mentioned. As the semiconductor material to be applied, not only DLC but also fluorine (F) containing DLC, titanium nitride and chromium nitride, etc., can be used. The average thickness of the coating film to be obtained may be set, for example, at about 1 μm.

### [Laser Processing Step]

First, as shown in FIG. 9A, the plate-form matrix 331 is prepared. A surface 331A of the plate-form matrix 331 to be processed is, for example, in mirror surface state. Note that the surface 331A may not be in a mirror surface state or may have smaller convexoconcave portions than those in the pattern to be transferred or may have convexoconcave portions which are the same as or coarser than those in the pattern to be transferred.

Next, using the laser processing apparatus shown in FIG. 8, the surface 331A of the plate-form matrix 331 is processed by a laser as follows. First, to the surface 331A of the plate-form matrix 331, an ultrashort pulsed-laser beam having a pulse width of 1 pico-second (10⁻¹² seconds) or less and called a femto second laser is applied to draw a pattern. For example, as shown in FIG. 9B, the surface 331A of the plate-form matrix 331 is irradiated with femto second laser light Lf and the irradiation spot is moved in a scanning manner.

At this time, the laser wavelength, repetitive frequency, pulse width, beam-spot shape, polarization, the intensity of the laser with which the surface 331A is irradiated and laser scanning speed, etc., are appropriately set. In this manner, a plurality of structures 332 having a desired shape are formed, as shown in FIG. 9C.

Next, if necessary, the surface-energy-lowering treatment is performed. This makes it possible to lower the surface energy of the structures 332.

### [Transfer Process]

A substrate 311 made of a resin having an uncured resin layer 333 formed thereon is prepared as shown in the cross sectional view of FIG. 10A.

Next, as shown in the cross sectional view of FIG. 10B, the plate-form matrix 331 is brought into contact with the uncured resin layer 333 formed on the substrate 311 made of a resin. The uncured resin layer 333 is irradiated with an active energy ray 334 to cure the uncured resin layer 333. In this manner, micro convex portions or micro concave portions of the plate-form matrix 331 is transferred to obtain an anti-fogging and anti-fouling layer 312 having micro convex portions or micro concave portions formed therein.

Finally, the anti-fogging and anti-fouling layer 312 thus formed is removed from the plate-form matrix 331 to obtain an anti-fogging and anti-fouling laminate (FIG. 10C).

Note that if a substrate 311 made of a resin is formed of a material which does not transmit an active energy ray such as ultraviolet rays, it is possible that the plate-form matrix 331 is formed of a material (for example, quartz), which can transmit an active energy ray, and the uncured resin layer 333 is irradiated with the active energy ray from the rear surface of the plate-form matrix 331 (the opposite surface to a molding surface).

### (Product)

The product of the present invention has the anti-fogging and anti-fouling laminate of the present invention as a surface and further has other members as necessary.

Examples of the product, which is not particularly limited and can be appropriately selected depending upon the purpose, include glass windows, refrigerating/freezing show case, window materials for automobile windows, bath mirrors, mirrors such as automobile side mirrors, floors and walls of bath rooms, solar battery panels and security/surveillance cameras.

The product may be a pair of glasses, goggles, head-gears, lenses, microlens arrays, and headlight covers, front panels, side panels and rear panels of automobiles. These are preferably formed by in-mold forming and insert molding.

The anti-fogging and anti-fouling laminate may be used as a part or whole of the surface of the product.

A method for manufacturing the product is not particularly limited and can be appropriately selected depending upon the purpose; however, the method for manufacturing the product of the present invention (described later) is preferable.

### (Method for Manufacturing the Product)

The method for manufacturing the product of the present invention at least has a heating step, an anti-fogging and anti-fouling laminate molding step and an injection molding step, and further has other steps as necessary.

The method for manufacturing the product is the method for manufacturing the product of the present invention.

### <Heating Step>

The heating step is not particularly limited and can be appropriately selected depending upon the purpose as long as it is a step of heating an anti-fogging and anti-fouling laminate.

The anti-fogging and anti-fouling laminate is the anti-fogging and anti-fouling laminate of the present invention.

The heating is not particularly limited and can be appropriately selected depending upon the purpose; however, infrared heating is preferable.

The heating temperature is not particularly limited and can be appropriately selected depending upon the purpose; however, the heating temperature is preferably near the glass transition temperature of the substrate made of a resin or the glass transition temperature or more.

The heating time is not particularly limited and can be appropriately selected depending upon the purpose.

### <Anti-Fogging and Anti-Fouling Laminate Molding Step>

The anti-fogging and anti-fouling laminate molding step is not particularly limited and can be appropriately selected depending upon the purpose as long as it is a step of molding the heated anti-fogging and anti-fouling laminate into a desired shape. The anti-fogging and anti-fouling laminate molding step is, for example, a step of bringing the laminate into contact with a predetermined mold and molding the laminate into a desired shape by application of air pressure.

### <Injection Molding Step>

The injection molding step is not particularly limited and can be appropriately selected depending upon the purpose as long as it is a step of injecting a molding material onto a substrate made of a resin of the anti-fogging and anti-fouling laminate molded into a desired shape and molding the molding material.

As the molding material, for example, a resin is mentioned. Examples of the resin include olefin resins, styrene resins, ABS resins (acrylonitrile-butadiene-styrene copolymers), AS resins (acrylonitrile-styrene copolymers), acrylic resins, urethane resins, unsaturated polyester resins, epoxy resins, polyphenylene oxide/polystyrene resins, polycarbonates, polycarbonate modified polyphenylene ethers, polyethylene terephthalates, polysulfones, polyphenylene sulfides, polyphenylene oxides, polyetherimides, polyimides, polyamides, liquid crystal polyesters, polyallyl heat-resistant resins, various types of complex resins and various types of modified resins.

The injection method is not particularly limited and can be appropriately selected depending upon the purpose. The injection method, for example, a method of injecting a molten molding material to a substrate made of a resin of the anti-fogging and anti-fouling laminate which is brought into contact with a predetermined die.

The method for manufacturing the product is preferably performed by use of an in-mold forming apparatus, an insert-molding apparatus, or an overlay molding apparatus.

Herein, an example of the method for manufacturing the product of the present invention will be described with reference to the accompanying drawings. The manufacturing method is a manufacturing method using an in-mold forming apparatus.

First, an anti-fogging and anti-fouling laminate 500 is heated. The heating is preferably performed by infrared heating.

Then, as shown in FIG. 11A, the anti-fogging and anti-fouling laminate 500 heated is disposed at a predetermined position between a first mold 501 and a second mold 502 in such a manner that the substrate made of a resin of the anti-fogging and anti-fouling laminate 500 faces the first mold 501; whereas the anti-fogging and anti-fouling layer faces the second mold 502. In FIG. 11A, the first mold 501 is to immovable; whereas the second mold 502 is movable.

After the anti-fogging and anti-fouling laminate 500 is disposed between the first mold 501 and the second mold 502, the first mold 501 and the second mold 502 are clamped. Subsequently, air is suctioned through a suction hole 504 having an opening in the cavity surface of the second mold 502 to fit the anti-fogging and anti-fouling laminate 500 along the cavity surface of the second mold 502. In this manner, the cavity surface is shaped by the anti-fogging and anti-fouling laminate 500. At this time, the periphery of the anti-fogging and anti-fouling laminate 500 may be immobilized by a film fixation mechanism (not shown) to set the anti-fogging and anti-fouling laminate. Thereafter, unnecessary portion of the anti-fogging and anti-fouling laminate 500 is trimmed away (FIG. 11B).

Note that if the second mold 502 has no suction hole 504 and the first mold 501 has a hole (not shown), pressurized air is fed through the hole of the first mold 501 toward the anti-fogging and anti-fouling laminate 500 to fit the anti-fogging and anti-fouling laminate 500 along the cavity surface of the second mold 502.

Subsequently, to the substrate made of a resin of the anti-fogging and anti-fouling laminate 500, a molten molding material 506 is injected through a gate 505 of the first mold 501 and poured in the cavity, which is formed of the first mold 501 and the second mold 502 by clamping (FIG. 11C). In this manner, the cavity is charged with the molten molding material 506 (FIG. 11D). After completion of charge with the molten molding material 506, the molten molding material 506 is cooled to a predetermined temperature and solidified.

Thereafter, the second mold 502 is moved to separate the first mold 501 and the second mold 502 (FIG. 11E). In this manner, the anti-fogging and anti-fouling laminate 500 is attached to the surface of the molding material 506 and a product 507 molded into a desired shape by in-mold forming can be obtained.

Finally, ejection pins 508 are pressed to remove the obtained product 507 from the first mold 501.

The manufacturing method using an overlay molding apparatus is as follows. This is a process of directly decorating the surface of a molding material with the anti-fogging and anti-fouling laminate, and one example thereof is TOM (Three dimension Overlay Method). Next, one example of the method for manufacturing the product of the present invention using the TOM will be described.

First, both spaces of an apparatus that is partitioned by the anti-fogging and anti-fouling laminate fixed in a fixing frame are vacuumed by sucking the air in the spaces with, for example, a vacuum pump.

At this time, a molding material previously formed by injection molding is placed in one of the spaces. At the same time, the anti-fogging and anti-fouling laminate is heated with an infrared heater until the temperature reaches a predetermined temperature at which the anti-fogging and anti-fouling laminate starts to soften. At the timing when the anti-fogging and anti-fouling laminate has been heated to soften, the anti-fogging and anti-fouling laminate is brought into contact with the three dimensional shape of the molding material under vacuum by feeding air into the space of the apparatus where the molding material is absent. If necessary, pressing with compressed air may further be employed in combination by feeding the compressed air to the space into which the air has been fed. After the anti-fogging and anti-fouling laminate has been brought into contact with the molding product, the resultant decorated molding product is removed from the fixing frame. This vacuum molding is generally carried out at 80° C. to 200° C., preferably at about 110° C. to about 160° C.

Upon overlay molding, in order to achieve adhesion between the anti-fogging and anti-fouling laminate and the molding material, an adhesive layer may be provided on the surface of the anti-fogging and anti-fouling laminate opposite to the anti-fogging and anti-fouling surface thereof. The adhesive layer is not particularly limited and can be appropriately selected depending upon the purpose. Examples of the adhesive layer include acrylic adhesives and hot-melt adhesives. The method for forming the adhesive layer is not particularly limited and can be appropriately selected depending upon the purpose. In one exemplary method for forming the adhesive layer, after the anti-fogging and anti-fouling layer has been formed on the substrate made of a resin, a coating liquid for forming an adhesive layer is coated on the surface of the substrate made of a resin opposite to the surface thereof that has been provided with the anti-fogging and anti-fouling layer, to thereby form the adhesive layer. In another employable method, a coating liquid for forming an adhesive layer is coated on a release sheet to form the adhesive layer, and then the substrate made of a resin and the adhesive layer on the release sheet are laminated on top of each other, to thereby laminate the adhesive layer on the substrate made of a resin.

Here, an example of the product of the present invention will be described with reference to the drawings.

FIG. 12 to FIG. 15 are each a schematic cross sectional view of an example of the product of the present invention.

The product of FIG. 12 includes a molding material 506, a substrate made of a resin 211, and an anti-fogging and anti-fouling layer 212, where the substrate made of a resin 211 and the anti-fogging and anti-fouling layer 212 are laminated on the molding material 506 in this order.

This product can be manufactured by, for example, insert molding.

The product of FIG. 13 includes a molding material 506, a substrate made of a resin 211, an anti-fogging and anti-fouling layer 212, and a hard coat layer 600, where the substrate made of a resin 211 and the anti-fogging and anti-fouling layer 212 are laminated on the molding material 506 in this order. The hard coat layer 600 is formed at the side of the molding material 506 opposite to the side where the substrate made of a resin 211 is present.

This product can be manufactured as follows, for example. Specifically, after manufacturing of the product of FIG. 12, a protective layer is formed on the anti-fogging and anti-fouling layer 212. Then, the hard coat layer 600 is formed on the surface of the molding material 506 by an immersion method, and the protective layer is removed.

The product of FIG. 14 includes a molding material 506, substrates made of a resin 211, and anti-fogging and anti-fouling layers 212, where each of the substrates made of a resin 211 and each of the anti-fogging and anti-fouling layers 212 are laminated on either side of the molding material 506 in this order.

The product of FIG. 15 includes a molding material 506, a substrate made of a resin 211, an anti-fogging and anti-fouling layer 212, and an optical film 601, where the substrate made of a resin 211 and the anti-fogging and anti-fouling layer 212 are laminated on the molding material 506 in this order. The optical film 601 is formed at the side of the molding material 506 opposite to the side where the substrate made of a resin 211 is present. Examples of the optical film 601 include a hard coat film, an anti-reflection film, an anti-glare film, and a polarizing film.

The product illustrated in FIG. 14 or FIG. 15 can be manufactured by, for example, double insert molding. Double insert molding is a method for molding a monolithic product with films laminated on both surfaces, and can be performed using, for example, the method described in Japanese Patent Application Laid-Open No. 03-114718.

### (Anti-Fouling Method)

The anti-fouling method of the present invention is a method for protecting the product from dirt by laminating the anti-fogging and anti-fouling laminate of the present invention onto the surface of a product.

Examples of the product, which is not particularly limited and can be appropriately selected depending upon the purpose, include glass windows, refrigerating/freezing show case, window materials for automobile windows, bath mirrors, mirrors such as automobile side mirrors, floors and walls of bath rooms, solar battery panels and security/surveillance cameras.

The product may be a pair of glasses, goggles, head-gears, lenses, microlens arrays, and headlight covers, front panels, side panels and rear panels of automobiles. These are preferably formed by in-mold forming and insert molding.

The method for laminating the anti-fogging and anti-fouling laminate onto the surface of a product is not particularly limited and can be appropriately selected depending upon the purpose. For example, a method for attaching the anti-fogging and anti-fouling laminate to a surface of the product is mentioned. The anti-fogging and anti-fouling laminate can be laminated onto a surface of the product also by the method for manufacturing the product of the present invention.

### EXAMPLES

Now, Examples of the present invention will be described; however the present invention is not limited to these Examples.

### <Average Distance Between Convex Portions, Average Distance Between Concave Portions, Average Height of Convex Portions, Average Depth of Concave Portions, Average Aspect Ratio and Average Surface Area Ratio>

In the following Examples, the average distance between convex portions, average distance between concave portions, average height of convex portions, average depth of concave portions, and average aspect ratio were obtained as follows.

First, the surface of an anti-fogging and anti-fouling layer having convex s1 portions or concave portions was observed by an atomic force microscope (AFM). From the section profile by the AFM, the pitch of convex portions or concave portions, the height of the convex portions or the depth of the concave portions were obtained. This procedure was repeated with respect to 10 sites randomly selected from the surface of the anti-fogging and anti-fouling layer to obtain pitch P1, P2, . . . , P10 and the height or depth H1, H2, . . . , H10.

The pitch of the convex portions herein is the distance between the peaks of convex portions. The pitch of the concave portion is the distance between the deepest portions of concave portions. The height of the convex portion is the height of the convex portion based on the lowest point of the valley portion between the convex portions. The depth of the concave portion is the depth of the concave portion based on the highest point of the mount portion between the concave portions.

Then, these pitches P1, P2, . . . , P10, and height or depth H1, H2, . . . , H10 were simply averaged (arithmetic average), respectively, to obtain the average distance (Pm) of convex portions or concave portions, average height of convex portions or the average depth (Hm) of the concave portions.

Based on the value Pm and the value Hm, the average aspect ratio (Hm/Pm) was obtained.

With respect to 10 sites randomly selected from the surface of an anti-fogging and anti-fouling layer having convex portions or concave portions, an AFM image was repeatedly taken to obtain surface areas S1, S2, . . . , S10. Next, the ratios of these surface areas S1, S2, . . . , S10 to the areas of the corresponding observation areas (surface area/area) SR1, SR2, . . . , SR10 were simply averaged (arithmetic average) to obtain average surface area ratio SRm of the surface of an anti-fogging and anti-fouling layer.

### <Pure Water Contact Angle>

The pure water contact angle was measured by the θ/2 method by use of a contact angle meter, PCA-1 (manufactured by Kyowa Interface Science Co., Ltd.) in the following conditions.
Distillation water was placed in a plastic syringe. To the tip of the syringe, a stainless steel needle was attached. The distillation water was allowed to drip on an evaluation surface.
The amount of water to be dripped: 2 μL
The measurement temperature: 25° C.

The contact angle 5 seconds after dripping of water was measured at randomly selected 10 points on the surface of the anti-fogging and anti-fouling layer, and the average value thereof was defined as the pure water contact angle.

### <Hexadecane Contact Angle>

The hexadecane contact angle was measured by the θ/2 method by use of a contact angle meter, PCA-1 (manufactured by Kyowa Interface Science Co., Ltd.) in the following conditions.
Hexadecane was placed in a plastic syringe. To the tip of the syringe, a TEFLON coated stainless steel needle was attached. The hexadecane was allowed to drip on an evaluation surface.
The amount of hexadecane to be dripped: 1 μL
The measurement temperature: 25° C.

The contact angle 20 seconds after dripping of hexadecane was measured at randomly selected 10 points on the surface of the anti-fogging and anti-fouling layer, and the average value thereof was defined as the hexadecane contact angle.

### <Anti-Fogging Property to Exhalation>

Immediately after the surface of the anti-fogging and anti-fouling layer was strongly breathed once from a place 5 cm apart from the surface in the normal line direction under an environment of 25° C. and 37% RH, the surface was visually observed and evaluated according to the following evaluation criteria.

### [Evaluation Criteria]

A: There was no change in appearance of the surface of the anti-fogging and anti-fouling layer.

B: Changes in appearance, such as white cloud and formation of a film of water, were observed in part of the surface of the anti-fogging and anti-fouling layer.

C: Changes in appearance, such as white cloud and formation of a film of water, were observed in the entirety of the surface of the anti-fogging and anti-fouling layer.

<Anti-Fogging Property to Exhalation after Immersion in Water>

The anti-fogging and anti-fouling laminate was immersed in distillation water of 25° C. for 10 seconds, taken out from the distillation water, and allowed to wait for the next cycle for 10 seconds. This cycle was repeated 30 times, and moisture attached to the anti-fogging and anti-fouling laminate was blown off by air blow. Immediately after the surface of the anti-fogging and anti-fouling layer was strongly breathed once from a place 5 cm apart from the surface in the normal line direction under an environment of 25° C. and 37% RH, the surface was visually observed and evaluated according to the following evaluation criteria.

### [Evaluation Criteria]

A: There was no change in appearance of the surface of the anti-fogging and anti-fouling layer.

B: Changes in appearance, such as white cloud and formation of a film of water, were observed in part of the surface of the anti-fogging and anti-fouling layer.

C: Changes in appearance, such as white cloud and formation of a film of water, were observed in the entirety of the surface of the anti-fogging and anti-fouling layer.

Note that, the purpose of evaluating anti-fogging property to exhalation after immersion in water is to confirm whether the anti-fogging and anti-fouling laminate or the product of the present invention can maintain anti-fogging property even after exposure to water, assuming that the anti-fogging and anti-fouling laminate or the product fall into water or are exposed to rain, or are used for applications involving exposure to water, such as goggles for use in water.

### <Martens Hardness>

The Martens hardness of the anti-fogging and anti-fouling layer was measured by use of PICODENTOR HM500 (trade name; Fischer Instruments K.K.). Measurement was performed by applying a load (1 mN/20 s) and using a diamond cone as a needle and at a face angle of 136°.

### <Elongation Percentage>

The elongation percentage was obtained by the following method.

The anti-fogging and anti-fouling laminate was cut into rectangular pieces of 10.5 cm in length×2.5 cm in width and used as measurement samples. The tension-elongation percentage of the measurement samples obtained was determined by a tension-tester (autograph AG-5kNX plus, manufactured by Shimadzu Corporation) in measurement conditions: (tension rate=100 mm/min; distance between chucks=8 cm, measurement temperature=150° C.).

### <Entire Light Beam Transmissivity>

The entire light beam transmissivity of the anti-fogging and anti-fouling laminate was evaluated in accordance with JIS K 7361 and by use of HM-150 (trade name; manufactured by MURAKAMI COLOR RESEARCH LABORATORY Co., Ltd).

### <Haze>

The haze of the anti-fogging and anti-fouling laminate was evaluated in accordance with JIS K 7136 and by use of HM-150 (trade name; manufactured by MURAKAMI COLOR RESEARCH LABORATORY Co., Ltd).

### <Heat and Moisture Resistance>

The surface of the anti-fogging and anti-fouling layer was exposed to water vapor of 80° C. for 3 minutes under an environment of 25° C. and 37% RH. The surface thereof was rinsed and dried and was evaluated according to the following evaluation criteria.

### [Evaluation Criteria]

A: There was no change in appearance in the anti-fogging and anti-fouling layer.

B: There were changes in appearance such as white cloud.

### <Abrasion Resistance>

A wiping cloth (SAVINA MX manufactured by KB Seiren, Ltd.) was placed on the surface of the anti-fogging and anti-fouling layer, and reciprocating sliding was repeated 1,000 times (sliding stroke: 3 cm, sliding frequency: 60 Hz) with a load of 500 gf/13 mm in diameter, and thereafter the abrasion resistance was evaluated according to the following criteria.

### [Evaluation Criteria]

A: There was no change in appearance, anti-fogging property to exhalation, and fingerprint wiping property.

B: One or more of the following: change in appearance such as scratch and white cloud; deterioration in anti-fogging property; and deterioration in fingerprint wiping property was observed.

### <Fingerprint Wiping Property>

A fingerprint was attached to the surface of the anti-fogging and anti-fouling s15 layer by an index finger, and this was wiped ten times in a circular motion with tissue (manufactured by Daio Paper Corporation, ELLEAIR). Thereafter; the surface was visually observed and evaluated according to the following evaluation criteria.

### [Evaluation Criteria]

A: The fingerprint disappeared.

B: The fingerprint remained.

### <Molding>

The produced anti-fogging and anti-fouling laminate was heated at 150° C. for 5 seconds through irradiation with infrared rays. The resultant was molded in the form of an 8 carve lens 80 mm in diameter by vacuum pressure molding so that the anti-fogging and anti-fouling layer would be a concave surface. The elongation percentage at the most elongated site of the anti-fogging and anti-fouling laminate was 75%. Thereafter, the Thomson blade was used to punch out the anti-fogging and anti-fouling laminate in the form of the 8 carve lens 80 mm in diameter. This was set in a mold for insert molding, and molten polycarbonate was charged thereto, followed 5 by cooling until the polycarbonate was solidified. The mold was opened to obtain an 8 curve lens having the anti-fogging and anti-fouling layer as a concave surface.

<<Appearance after Molding>>

The obtained 8 curve lens was visually observed and evaluated according to the following evaluation criteria.

### [Evaluation Criteria]

A: There was no defect in appearance in the anti-fogging and anti-fouling layer, such as a scratch, a crack, and peeling.

B: There were defects in appearance in the anti-fogging and anti-fouling layer, such as a scratch, a crack, and peeling.

<Anti-Fogging Property to Exhalation after Molding>

Immediately after the surface of the anti-fogging and anti-fouling layer was strongly breathed once from a place 5 cm apart from the central portion of the lens in the normal line direction under an environment of 25° C. and 37% RH, the surface was visually observed and evaluated according to the following evaluation criteria.

### [Evaluation Criteria]

A: There was no change in appearance of the surface of the anti-fogging and anti-fouling layer.

B: Changes in appearance, such as white cloud and formation of a film of water, were observed in part of the surface of the anti-fogging and anti-fouling layer.

C: Changes in appearance, such as white cloud and formation of a film of water, were observed in the entirety of the surface of the anti-fogging and anti-fouling layer.

### Example 1

### <Preparation of Transfer Matrix (Glass Roll Matrix) Having Either One of Micro Convex Portions and Concave Portions>

Firstly, a glass roll matrix having an outer diameter of 126 mm was prepared, and a resist layer was formed on the surface of the glass roll matrix in the following manner. Namely, a photoresist was diluted 1/10 by mass ratio with a thinner, and the diluted resist was applied to the cylindrical surface of the glass roll matrix in an average thickness of about 70 nm by a dipping method to form a resist layer. Next, the glass roll matrix was conveyed to an exposure apparatus for a roll matrix shown in FIG. 4, the resist layer was exposed, and thereby latent images lying in a spiral manner and forming a hexagonal lattice pattern between adjacent three rows of tracks was patterned on the resist layer. Specifically, an exposure pattern having a hexagonal lattice shape was formed by applying a 0.50 mW/m laser beam to a region where the exposure pattern having a hexagonal lattice shape to be formed.

Next, development processing was applied to the resist layer on the glass roll matrix, and the development was carried out by dissolving the resist layer of the exposed part. Specifically, the undeveloped glass roll matrix was mounted on a turntable of the developing apparatus not shown in the figure, developing solution was dropped on the surface of the glass roll matrix while the glass roll matrix was rotated with the turntable, and the resist layer on the surface of the glass roll matrix was developed. Thereby, a resist glass matrix in which the resist layer is open in a hexagonal lattice pattern was obtained.

Next, plasma etching was carried out under a CHFs gas atmosphere using a roll etching apparatus. Thereby, etching progressed at only the hexagonal lattice pattern part exposed from the resist layer on the surface of the glass roll matrix, and the other regions were not etched because the resist layer worked as a mask, and concave portions having an elliptic cone shape were formed on the glass roll matrix. In the etching, the amount of etching (depth) was adjusted by the etching time. Next, the resist layer was completely removed by O₂ ashing.

Subsequently, a fluorine-containing silane coupling agent (OPTOOL DSX manufactured by DAIKIN INDUSTRIES, LTD.) was dip coated on the surface of the glass roll matrix, followed by baking at 100° C. for 90 minutes.

Through the above procedure, a glass roll matrix having a hexagonal lattice pattern of a concave shape was obtained. The pure water contact angle of the surface of the obtained glass roll matrix was 120°.

### <Preparation of Anti-Fogging and Anti-Fouling Laminate>

Next, an anti-fogging and anti-fouling laminate was prepared using the glass roll matrix obtained in the manner described above by a UV imprint. Specifically, the preparation was carried out in the following manner.

As a substrate made of a resin, FE-2000 (PC substrate, average thickness: 180 μm) manufactured by Mitsubishi Gas Chemical Co., Inc. was used.

The surface of the substrate made of a resin was subjected to a corona treatment.

Next, a curable resin composition having the following formulation was applied to the substrate made of a resin so that the average thickness of the anti-fogging and anti-fouling layer to be obtained became 2.5 μm. The substrate made of a resin to which the curable resin composition was applied and the glass roll matrix obtained in the manner as described above were brought into contact with each other, and the anti-fogging and anti-fouling layer was cured by irradiating an ultraviolet ray from the side of the substrate made of a resin at an irradiation amount of 1,000 mJ/cm² using a metal halide lamp. Thereafter, the anti-fogging and anti-fouling layer was peeled from the roll matrix.

### —Curable Resin Composition—

KY-1203 (fluorine-containing acrylate, manufactured by Shin-Etsu Chemical Co., Ltd.): 1 part by mass
A-600 (waterabsorbable acrylate, manufactured by Shin-Nakamura Chemical Co., Ltd): 48 parts by mass
M-313 (isocyanuric acid group-containing acrylate, manufactured by TOAGOSEI CO., LTD.): 48 parts by mass
Lucirin TPO (photopolymerization initiator, manufactured by BASF Inc.): 3 parts by mass

Through the above procedure, an anti-fogging and anti-fouling laminate having micro convex portions on the surface of the anti-fogging and anti-fouling layer was obtained. The obtained anti-fogging and anti-fouling laminate was evaluated. The results are shown in Table 1-1 and Table 1-2. FIG. 16A is an AFM image showing the surface of the anti-fogging and anti-fouling layer of the obtained anti-fogging and anti-fouling laminate. FIG. 16B is a cross sectional view along the a-a line in FIG. 16A.

### Example 2

An anti-fogging and anti-fouling laminate was prepared in the same manner as in Example 1 except that the curable resin composition was changed to the following curable resin composition.

### —Curable Resin Composition—

KY-1203 (fluorine-containing acrylate, manufactured by Shin-Etsu Chemical Co., Ltd.): 1 part by mass
A-600 (water-absorbable acrylate, manufactured by Shin-Nakamura Chemical Co., Ltd): 38.4 parts by mass
M-313 (isocyanuric acid group-containing acrylate, manufactured by TOAGOSEI CO., LTD.): 57.6 parts by mass
Lucirin TPO (photopolymerization initiator, manufactured by BASF Inc.): 3 parts by mass

The prepared anti-fogging and anti-fouling laminate was evaluated in the same manner as in Example 1. The results are shown in Table 1-1 and Table 1-2.

### Example 3

An anti-fogging and anti-fouling laminate was prepared in the same manner as in Example 1 except that the curable resin composition was changed to the following curable resin composition.

### —Curable Resin Composition

KY-1203 (fluorine-containing acrylate, manufactured by Shin-Etsu Chemical Co., Ltd.): 1 part by mass
A-600 (water-absorbable acrylate, manufactured by Shin-Nakamura Chemical Co., Ltd): 57.6 parts by mass
M-313 (isocyanuric acid group-containing acrylate, manufactured by TOAGOSEI CO., LTD.): 38.4 parts by mass
Lucirin TPO (photopolymerization initiator, manufactured by BASF Inc.): 3 parts by mass

The prepared anti-fogging and anti-fouling laminate was evaluated in the same manner as in Example 1. The results are shown in Table 1-1 and Table 1-2.

### Example 4

An anti-fogging and anti-fouling laminate was prepared in the same manner as in Example 1 except that DF02U (PC/PMMA laminate substrate) (average thickness: 180 μm) manufactured by Mitsubishi Gas Chemical Co., Inc. was used as the substrate made of a resin, no corona treatment was performed, and the curable resin composition was applied to the PMMA surface.

The prepared anti-fogging and anti-fouling laminate was evaluated in the same manner as in Example 1. The results are shown in Table 1-1 and Table 1-2.

### Example 5

As a substrate made of a resin, DF02U (PC/PMMA laminate substrate, average thickness: 180 μm) manufactured by Mitsubishi Gas Chemical Co., Inc. was used.

An ultraviolet curable resin composition for an anchor layer having the following formulation was applied to the PMMA surface of the substrate made of a resin so that the average thickness after drying and curing became 0.7 μm.

### —Ultraviolet Curable Resin Composition for Anchor Layer—

CN985B88 (aliphatic urethane acrylate, manufactured by Sartomer): 15 parts by mass
A-9300-1CL (isocyanuric acid-containing triacrylate) (manufactured by Shin-Nakamura Chemical Co., Ltd): 15 parts by mass
Butyl acetate (solvent): 68.8 parts by mass
KP-323 (leveling agent, manufactured by Shin-Nakamura Chemical Co., Ltd): 0.003 parts by mass
IRGACURE 184 (photopolymerization initiator, manufactured by BASF Inc.): 0.6 parts by mass
IRGACURE 907 (photopolymerization initiator, manufactured by BASF Inc.): 0.6 parts by mass

After drying, an ultraviolet ray having an irradiation amount of 500 mJ/cm² was irradiated to the uncured anchor layer using a mercury lamp to obtain an ultraviolet cured substrate made of a resin and having an anchor layer.

In the same manner as in Example 4 except that this was used as a substrate and the curable resin composition was applied on the anchor layer, an anti-fogging and anti-fouling laminate was prepared.

The prepared anti-fogging and anti-fouling laminate was evaluated in the same manner as in Example 1. The results are shown in Table 1-1 and Table 1-2.

Note that, the interference irregularity was reduced as compared with the anti-fogging and anti-fouling laminate of Example 4.

### Example 6

An anti-fogging and anti-fouling laminate was prepared in the same manner as in Example 1 except that the etching time for preparing the glass roll matrix was changed.

The prepared anti-fogging and anti-fouling laminate was evaluated in the same manner as in Example 1. The results are shown in Table 1-1 and Table 1-2.

### Example 7

An anti-fogging and anti-fouling laminate was prepared in the same manner as in Example 1 except that the etching time for preparing the glass roll matrix was changed.

The prepared anti-fogging and anti-fouling laminate was evaluated in the same manner as in Example 1. The results are shown in Table 1-1 and Table 1-2.

### Example 8

An anti-fogging and anti-fouling laminate was prepared in the same manner as in Example 1 except that the etching time for preparing the glass roll matrix was changed.

The prepared anti-fogging and anti-fouling laminate was evaluated in the same manner as in Example 1. The results are shown in Table 1-1 and Table 1-2.

### Example 9

An anti-fogging and anti-fouling laminate was prepared in the same manner as in Example 1 except that the curable resin composition was changed to the following curable resin composition.

### —Curable Resin Composition—

KY-1203 (fluorine-containing acrylate, manufactured by Shin-Etsu Chemical Co., Ltd.): 1 part by mass
A-600 (water-absorbable acrylate, manufactured by Shin-Nakamura Chemical Co., Ltd): 30 parts by mass
A-GLY-20E (water-absorbable acrylate, manufactured by Shin-Nakamura Chemical Co., Ltd): 18 parts by mass
PETIA (pentaerythritolacrylate, manufactured by DAICEL-ALLNEX LTD.): 48 parts by mass
Lucirin TPO (photopolymerization initiator, manufactured by BASF Inc.): 3 parts by mass

The prepared anti-fogging and anti-fouling laminate was evaluated in the same manner as in Example 1. The results are shown in Table 1-1 and Table 1-2.

### Example 10

An anti-fogging and anti-fouling laminate was prepared in the same manner as in Example 1 except that the curable resin composition was changed to the following curable resin composition.

### —Curable Resin Composition—

KY-1203 (fluorine-containing acrylate, manufactured by Shin-Etsu Chemical Co., Ltd.): 1 part by mass
A-600 (water-absorbable acrylate, manufactured by Shin-Nakamura Chemical Co., Ltd): 67.2 parts by mass
M-313 (isocyanuric acid group-containing acrylate, manufactured by TOAGOSEI CO., LTD.): 28.8 parts by mass
Lucirin TPO (photopolymerization initiator, manufactured by BASF Inc.): 3 parts by mass

The prepared anti-fogging and anti-fouling laminate was evaluated in the same manner as in Example 1. The results are shown in Table 1-1 and Table 1-2.

### Comparative Example 1

A laminate was prepared in the same manner as in Example 1 except that the curable resin composition was changed to the following curable resin composition.

### —Curable Resin Composition—

A-600 (water-absorbable acrylate, manufactured by Shin-Nakamura Chemical Co., Ltd): 43 parts by mass
M-215 (isocyanuric acid group-containing acrylate, manufactured by TOAGOSEI CO., LTD.): 43 parts by mass
LIGHT ESTER THF (1000) (THF modified methacrylate, manufactured by KYOEISHA CHEMICAL Co., LTD.): 10 parts by mass
Lucirin TPO (photopolymerization initiator, manufactured by BASF Inc.): 4 parts by mass

The prepared laminate was evaluated in the same manner as in Example 1.

The results are shown in Table 1-1 and Table 1-2.

### Comparative Example 2

A laminate was prepared in the same manner as in Example 1 except that the curable resin composition was changed to the following curable resin composition.

### —Curable Resin Composition—

KY-1203 (fluorine-containing acrylate, manufactured by Shin-Etsu Chemical Co., Ltd.): 0.9 part by mass
M-313 (isocyanuric acid group-containing acrylate, manufactured by TOAGOSEI CO., LTD.): 86.4 parts by mass
Lucirin TPO (photopolymerization initiator, manufactured by BASF Inc.): 2.7 parts by mass
MEK (solvent): 10 parts by mass

The prepared laminate was evaluated in the same manner as in Example 1. The results are shown in Table 1-1 and Table 1-2.

### Comparative Example 3

As a substrate of a resin, U483 manufactured by Tobray Industries, Inc. (PET substrate, average thickness: 100 μm) was used.

The curable resin composition used in Example 1 was applied to the substrate of a resin so that the average thickness of the resin layer to be obtained became 2.5 μm.

Subsequently, without using the glass roll matrix, the resin layer was cured by irradiating an ultraviolet ray from the side of the substrate made of a resin at an irradiation amount of 1,000 mJ/cm² using a metal halide lamp, to thereby obtain a laminate.

The prepared laminate was evaluated in the same manner as in Example 1. The results are shown in Table 1-1 and Table 1-2.

TABLE 1-1

| | | | | | | | | | | Anti- | | |
|---|---|---|---|---|---|---|---|---|---|---|---|---|
| | | | | | | | | | | fogging | | |
| | | Anti-fogging and anti-fouling layer | | | | | Pure | Hexa- | Anti- | property to | | |
| | | | | | | Avg. | water | decane | fogging | exhalation | | |
| | | | | | | thick- | contact | contact | property | after | Martens | Elongation |
| | | Pm | Hm | Hm/ | | ness | angle | angle | to | immersion | hardness | percentage |
| | Substrate | (nm) | (nm) | Pm | SRm | (μm) | (°) | (°) | exhalation | in water | (N/mm²) | (%) |
| Ex. 1 | PC | 250 | 220 | 0.88 | 2.4 | 2.5 | 122 | 83 | A | A | 42 | 100 |
| Ex. 2 | PC | 250 | 220 | 0.88 | 2.4 | 2.5 | 145 | 83 | A | A | 78 | 75 |
| Ex. 3 | PC | 250 | 220 | 0.88 | 2.4 | 2.5 | 135 | 83 | A | A | 38 | 120 |
| Ex. 4 | PC/ | 250 | 220 | 0.88 | 2.4 | 2.5 | 122 | 83 | A | A | 42 | 100 |
| | PMMA | | | | | | | | | | | |
| Ex. 5 | PC/ | 250 | 220 | 0.88 | 2.4 | 2.5 | 122 | 83 | A | A | 42 | 100 |
| | PMMA/ | | | | | | | | | | | |
| | anchor | | | | | | | | | | | |
| Ex. 6 | PC | 250 | 150 | 0.60 | 1.8 | 2.5 | 125 | 82 | A | A | 42 | 100 |
| Ex. 7 | PC | 250 | 100 | 0.40 | 1.5 | 2.5 | 123 | 83 | A | A | 42 | 100 |
| Ex. 8 | PC | 250 | 70 | 0.28 | 1.1 | 2.5 | 115 | 79 | A | A | 42 | 100 |
| Ex. 9 | PC | 250 | 220 | 0.88 | 2.4 | 2.5 | 129 | 81 | A | A | 50 | 100 |
| Ex. 10 | PC | 250 | 220 | 0.88 | 2.4 | 2.5 | 120 | 84 | A | A | 16 | — |
| Comp. | PC | 250 | 220 | 0.88 | 2.4 | 2.5 | 5 | 13 | A | B | 76 | 75 |
| Ex. 1 | | | | | | | | | | | | |
| Comp. | PC | 250 | 220 | 0.88 | 2.4 | 2.5 | 150 | — | C | C | — | — |
| Ex. 2 | | | | | | | | | | | | |

| | | | | | | | | | | |
|---|---|---|---|---|---|---|---|---|---|---|
| Comp. | PET | Flat film | 1 | 2.5 | 110 | 64 | B | B | 78 | — |
| Ex. 3 | | | | | | | | | | |

TABLE 1-2

| | | | | | | | Entire | | | | | | |
|---|---|---|---|---|---|---|---|---|---|---|---|---|---|
| | | Anti-fogging and | | | | | light | | | | | After molding | |
| | | anti-fouling layer | | | | | beam | | Heat | | | | Anti- |
| | | | | | | Avg. | trans- | | and | Abra- | Finger- | | fogging |
| | | | | | | thick- | mis- | | moisture | sion | print | | property |
| | | Pm | Hm | Hm/ | | ness | sivity | Haze | resist- | resist- | wiping | Appear- | to |
| | Substrate | (nm) | (nm) | Pm | SRm | (μm) | (%) | (%) | ance | ance | property | ance | exhalation |
| Ex. 1 | PC | 250 | 220 | 0.88 | 2.4 | 2.5 | 94.0 | 0.6 | A | A | A | A | A |
| Ex. 2 | PC | 250 | 220 | 0.88 | 2.4 | 2.5 | 94.0 | 0.6 | A | A | A | A | A |
| Ex. 3 | PC | 250 | 220 | 0.88 | 2.4 | 2.5 | 93.9 | 0.5 | A | A | A | A | A |
| Ex. 4 | PC/ | 250 | 220 | 0.88 | 2.4 | 2.5 | 93.9 | 0.5 | A | A | A | A | A |
| | PMMA | | | | | | | | | | | | |
| Ex. 5 | PC/ | 250 | 220 | 0.88 | 2.4 | 2.5 | 93.9 | 0.5 | A | A | A | A | A |
| | PMMA/ | | | | | | | | | | | | |
| | anchor | | | | | | | | | | | | |
| Ex. 6 | PC | 250 | 150 | 0.60 | 1.8 | 2.5 | 93.3 | 0.6 | A | A | A | A | A |
| Ex. 7 | PC | 250 | 100 | 0.40 | 1.5 | 2.5 | 93.0 | 0.6 | A | A | A | A | A |
| Ex. 8 | PC | 250 | 70 | 0.28 | 1.1 | 2.5 | 92.5 | 0.6 | A | A | A | A | A |
| Ex. 9 | PC | 250 | 220 | 0.88 | 2.4 | 2.5 | 94.0 | 0.5 | A | A | A | A | A |
| Ex. 10 | PC | 250 | 220 | 0.88 | 2.4 | 2.5 | 94.0 | 0.5 | B | B | A | A | A |
| Comp. | PC | 250 | 220 | 0.88 | 2.4 | 2.5 | 94.0 | 0.5 | A | A | B | A | A |
| Ex. 1 | | | | | | | | | | | | | |
| Comp. | PC | 250 | 220 | 0.88 | 2.4 | 2.5 | — | — | — | — | — | — | — |
| Ex. 2 | | | | | | | | | | | | | |

| | | | | | | | | | | | |
|---|---|---|---|---|---|---|---|---|---|---|---|
| Comp. | PET | Flat film | 1.0 | 2.5 | 91.4 | 0.8 | A | A | A | — | — |
| Ex. 3 | | | | | | | | | | | |

In Table 1-1 and Table 1-2, “-” means not being evaluated.

In the present invention, the anti-fogging and anti-fouling laminate excellent in anti-fogging property and anti-fouling property was efficiently obtained without a multistep process.

Comparison of Examples 1 to 10 with Comparative Example 1 indicates that when the uppermost surface of the anti-fogging and anti-fouling layer is formed of the fluorine-containing compound, excellent fingerprint wiping property is obtained.

Comparison of Examples 1 to 10 with Comparative Example 1 indicates that when the uppermost surface of the anti-fogging and anti-fouling layer is formed of the fluorine-containing compound, permeation of moisture into the anti-fogging and anti-fouling layer is suppressed during immersion in water, and excellent anti-fogging property to exhalation is obtained even after immersion in water.

Comparison of Examples 1 to 10 with Comparative Example 2 indicates that when the bulk of the anti-fogging and anti-fouling layer contains a compound having water-absorbable property, excellent anti-fogging property to exhalation is obtained.

Comparison of Example 2 with Comparative Example 3 indicates that water vapor is easily incorporated into the anti-fogging and anti-fouling layer as a result of increased SRm by the micro concave and convex portions, which leads to improvement in anti-fogging property to exhalation.

Comparison of Examples 1 to 9 with Example 10 indicates that the high Martens hardness (the extent to which the anti-fogging and anti-fouling layer was cured) results in excellent heat and moisture resistance and abrasion resistance.

### INDUSTRIAL APPLICABILITY

The anti-fogging and anti-fouling laminate of the present invention can be used by attaching to glass windows, refrigerating/freezing show case, window materials for automobile windows, bath mirrors, mirrors such as side automobile mirrors, floors and walls of bath rooms, solar battery panels and security/surveillance cameras. Since the anti-fogging and anti-fouling laminate of the present invention is easily molded and processed, the laminate can be used in a pair of glasses, goggles, head-gears, lenses, microlens arrays, and headlight covers, front panels, side panels and rear panels of automobiles by means of in-mold forming or insert molding.

### REFERENCE SIGNS LIST

211 substrate made of a resin
212 anti-fogging and anti-fouling layer
231 roll matrix
232 structure
236 uncured resin layer
237 active energy ray
311 substrate made of a resin
312 anti-fogging and anti-fouling layer
331 plate-form matrix
332 structure
333 uncured resin layer
334 active energy ray

1. An anti-fogging and anti-fouling laminate, comprising:
a substrate made of a resin; and
an anti-fogging and anti-fouling layer on the substrate made of a resin,
wherein the anti-fogging and anti-fouling layer comprises micro convex portions or micro concave portions in a surface thereof,
wherein the anti-fogging and anti-fouling layer comprises a hydrophilic molecular structure, and
wherein a pure water contact angle of the surface of the anti-fogging and anti-fouling layer is 90° or more.

2. The anti-fogging and anti-fouling laminate according to claim 1, wherein an elongation percentage of the anti-fogging and anti-fouling laminate is 10% or more.

3. The anti-fogging and anti-fouling laminate according to claim 1, wherein a Martens hardness of the anti-fogging and anti-fouling layer is 20 N/mm² to 300 N/mm².

4. The anti-fogging and anti-fouling laminate according to claim 1, wherein an average surface area ratio of the anti-fogging and anti-fouling layer is 1.1 or more.

5. The anti-fogging and anti-fouling laminate according to claim 1, wherein the anti-fogging and anti-fouling layer comprises a cured product of an active energy ray curable resin composition, and the active energy ray curable resin composition comprises an organic compound comprising at least one of fluorine and silicon.

6. The anti-fogging and anti-fouling laminate according to claim 5, wherein the active energy ray curable resin composition comprises a compound comprising at least one of a polyoxyalkyl group and a polyoxyalkylene group.

7. A method for manufacturing the anti-fogging and anti-fouling laminate according to claim 1, the method comprising:
forming an uncured resin layer by applying an active energy ray curable resin composition to a substrate made of a resin; and
forming an anti-fogging and anti-fouling layer by bringing a transfer matrix comprising micro convex portions or micro concave portions into contact with the uncured resin layer, irradiating the uncured resin layer in contact with the transfer matrix with an active energy ray to cure the uncured resin layer, thereby transferring the micro convex portions or the micro concave portions.

8. The method for manufacturing an anti-fogging and anti-fouling laminate according to claim 7, wherein a surface of the transfer matrix to be brought into contact with the uncured resin layer is treated with a compound comprising at least one of fluorine and silicon.

9. The method for manufacturing an anti-fogging and anti-fouling laminate according to claim 7, wherein the micro convex portions or the micro concave portions of the transfer matrix are formed by etching a surface of the transfer matrix with a photoresist having a predetermined pattern shape used as a protective film.

10. The method for manufacturing an anti-fogging and anti-fouling laminate according to claim 7, wherein the micro convex portions or the micro concave portions of the transfer matrix are formed by laser processing of a surface of the transfer matrix by irradiating the surface of the transfer matrix with a laser beam.

11. A product, comprising:
an anti-fogging and anti-fouling laminate on a surface thereof, the anti-fogging and anti-fouling laminate being the anti-fogging and anti-fouling laminate according to claim 1.

12. A method for manufacturing the product according to claim 11, the method comprising:
heating the anti-fogging and anti-fouling laminate;
molding the anti-fogging and anti-fouling laminate heated into a desired shape; and
injecting a molding material to the anti-fogging and anti-fouling laminate molded in the desired shape at a side of a substrate made of a resin and molding the molding material.

13. The method for manufacturing the product according to claim 12, wherein the heating is performed by infrared heating.

14. An anti-fouling method for protecting a product from getting dirty, the method comprising:
laminating an anti-fogging and anti-fouling laminate on a surface of the product, the anti-fogging and anti-fouling laminate being the anti-fogging and anti-fouling laminate according to claim 1.
